(19) United States
(12) Patent Application Publication
(10) Pub. No.: US 2012/0290601 A1
(43) Pub. Date: Nov. 15, 2012

(54) Image-based Data Management Method and System

(75) Inventor: Yung-Chun Huang, Ming-Hang District (CN)

(73) Assignee: Master Wave International Co., Ltd.

(21) Appl. No.: 12/763,172

(22) Filed: Apr. 19, 2010

Related U.S. Application Data
(63) Continuation-in-part of application No. 11/985,642, filed on Nov. 15, 2007, now Pat. No. 8,244,037.
(60) Provisional application No. 61/170,974, filed on Apr. 20, 2009.

(51) Int. Cl. G06F 3/048; G06F 17/30

(52) U.S. Cl. 707/769; 715/716; 715/764; 715/738; 715/758; 707/756; 707/E17.005; 707/E17.014; 707/785; 707/E17.045

(57) ABSTRACT

Methods and systems are provided for storing, organizing, accessing, and communicating using image-based documents. A computer-implemented method for online communication using business cards includes receiving a business card in image format, conducting an optical character recognition (OCR) conversion process to produce an equivalent business card in text format, identifying keywords of the equivalent business card in text format, linking the keywords with the business card in image format and the corresponding equivalent business card in text format, attaching user-provided privacy setting of permissions of accessibility to the business card, attaching user-provided contents to the business card, and providing information of the business card and its associated contents online to one or more users according to the user-provided privacy setting of permissions of accessibility to the business card.

### CROSS-REFERENCE TO RELATED APPLICATION

This application is a continuation-in-part application and claims the benefit of co-pending U.S. application Ser. No. 11/985,642, “Image-based Data Management Method and System,” filed Nov. 15, 2007; which is assigned to Master Wave International Company, Ltd. This application also claims the benefit of provisional application bearing Ser. No. 61/170,974, filed Apr. 20, 2009. The aforementioned United States applications are hereby incorporated by reference in their entirety.

### FIELD OF THE INVENTION

The present invention relates to the field of data management systems. In particular, the present invention relates to a method and system for storing, organizing, and accessing image-based data.

### BACKGROUND OF THE INVENTION

FIG. 1 illustrates a conventional method for storing image-based data. In the traditional approach, Text information of an original image-based document 102 is entered into the computer manually 104, and the manually entered text information is saved in a database 106 for future use. Though the conventional method typically preserves the text information of the original document, it does not preserve other information accompanying the text in the original document, such as the color, layout, typesetting, etc, which may carry important information about the original document. Therefore, in the event the original document 102 is lost, not all contents of the original document can be recovered from the database 106.

Therefore, there is a need for addressing the issues of the conventional method for storing image-based data.

### SUMMARY

With the rapid development of information technologies, information carried by image contents has increased exponentially. Some commonly used image formats include .bmp, .gif, .jpg, .pdf, , etc. Image-based documents may be easily entered into a computer. To do so, people may use devices like digital cameras or scanners to transfer image-based documents into the computer, for example a snapshot of a train schedule taken at the train station, a scanned image of a business card, or a microfilm image of a library collection. By using the data management system of the present invention based on images of the original document, vast amount of information may be accumulated very quickly. As a result, demands for searching such image-based document are generated. To address the need of searching such image-based document, methods and systems for storing, managing, and access image-based documents are disclosed.

In one embodiment, an electronic business card includes a front side of the business card configured to include business contact information, a back side of the business card configured to include multimedia contents attached to the business card, a privacy setting configured to set permissions of accessibility to the business card, and an editor configured to edit contents on both the front side and back side of the business card.

In another embodiment, a computer-implemented method for online communication using business cards includes receiving a business card in image format, conducting an optical character recognition (OCR) conversion process to produce an equivalent business card in text format, identifying keywords of the equivalent business card in text format, linking the keywords with the business card in image format and the corresponding equivalent business card in text format, attaching user-provided privacy setting of permissions of accessibility to the business card, attaching user-provided contents to the business card, and providing information of the business card and its associated contents online to one or more users according to the user-provided privacy setting of permissions of accessibility to the business card.

In yet another embodiment, a computer-implemented method for searching image-based data includes receiving an image-based document, conducting an optical character recognition (OCR) conversion process to produce an equivalent document in text format, identifying keywords of the equivalent document in text format, linking the keywords with the image-based document and the corresponding equivalent document in text format, storing the image-based document, the corresponding equivalent document in text format, and the keywords in a relational database, searching against the keywords and the equivalent document in text format in the relational database in accordance with a search query, and displaying the image-based document and the corresponding equivalent document in text format in response to one or more keywords that match the search query as search results.

### BRIEF DESCRIPTION OF THE DRAWINGS

The aforementioned features and advantages of the invention, as well as additional features and advantages thereof, will be more clearly understandable after reading detailed descriptions of embodiments of the invention in conjunction with the following drawings.

FIG. 1 illustrates a conventional method for storing image-based data.

FIG. 2 illustrates a method for storing and organizing image-based data according to an embodiment of the present invention.

FIG. 3 illustrates a method for searching information from the relational database of FIG. 2 according to an embodiment of the present invention.

FIG. 4A illustrates an implementation of processing image-based data at a client site according to an embodiment of the present invention.

FIG. 4B illustrates an implementation of processing image-based data at a server site according to an embodiment of the present invention.

FIGS. 5A-5E illustrate a method for storing, organizing, and accessing business cards according to embodiments of the present invention.

FIG. 6 illustrates a method for accessing and using saved business cards according to an embodiment of the present invention.

FIG. 7 illustrates a method for displaying saved business cards according to an embodiment of the present invention.

FIG. 8 illustrates a system for organizing business cards according to an embodiment of the present invention.

FIGS. 9A-9C illustrate methods for organizing business cards according to embodiments of the present invention.

FIGS. 10A-10C illustrate methods for using back of a business card according to embodiments of the present invention.

FIGS. 11A-11C illustrate methods for communicating information on a business card according embodiments of the present invention.

FIGS. 12A-12B illustrate methods for conducting a public search of business cards according to embodiments of the present invention.

FIGS. 13A-13C illustrate methods for editing a business card according to embodiments of the present invention.

FIG. 14A-14C illustrate methods for attaching photos to a business card according to embodiments of the present invention.

FIGS. 15A-15C illustrate methods for attaching videos to a business card according to embodiments of the present invention.

FIGS. 16A-16C illustrate methods for attaching message bulletin to a business card according to embodiments of the present invention.

FIGS. 17A-17C illustrate methods for attaching links to a business card according to embodiments of the present invention.

FIGS. 18A-18C illustrate methods for attaching live blogs to a business card according to embodiments of the present invention.

Like numbers are used throughout the figures.

### DESCRIPTION OF EMBODIMENTS

Methods and systems are provided for storing, managing, and accessing image-based documents. The following descriptions are presented to enable any person skilled in the art to make and use the invention. Descriptions of specific embodiments and applications are provided only as examples. Various modifications and combinations of the examples described herein will be readily apparent to those skilled in the art, and the general principles defined herein may be applied to other examples and applications without departing from the spirit and scope of the invention. Thus, the present invention is not intended to be limited to the examples described and shown, but is to be accorded the widest scope consistent with the principles and features disclosed herein.

Some portions of the detailed description that follows are presented in terms of flowcharts, logic blocks, and other symbolic representations of operations on information that can be performed on a computer system. A procedure, computer-executed step, logic block, process, etc., is here conceived to be a self-consistent sequence of one or more steps or instructions leading to a desired result. The steps are those utilizing physical manipulations of physical quantities. These quantities can take the form of electrical, magnetic, or radio signals capable of being stored, transferred, combined, compared, and otherwise manipulated in a computer system. These signals may be referred to at times as bits, values, elements, symbols, characters, terms, numbers, or the like. Each step may be performed by hardware, software, firmware, or combinations thereof.

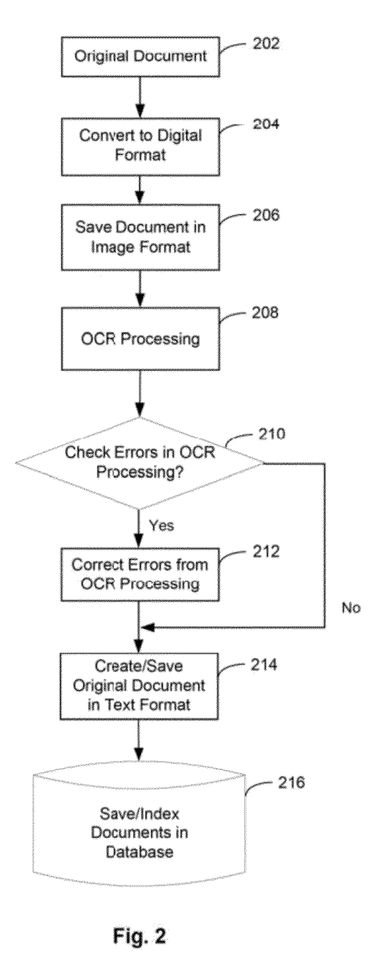

FIG. 2 illustrates a method for storing and organizing image-based data according to an embodiment of the present invention. As shown in FIG. 2, the method starts with an original document in block 202, which may be a book, magazine, business card, product manual, fax, or information presented in other formats. In block 204, the method converts the original document to digital format using commonly available equipments, such as scanners, digital cameras, or other digital input devices. In block 206, the converted image-based document is saved in a digital format in a computer. In particular, the image-based documents may be saved in .jpg, .pdf, .tiff, or other digital formats.

In block 208, the method performs an optical character recognition (OCR) conversion process to convert the image-based data saved in block 206 to a text format. This process is accomplished by recognizing the character information in the image format of the original document. Note that the current OCR conversion process does not produce a 100% correct recognition rate. Thus, some characters in the original document may be incorrectly recognized. Since errors may be introduced by the OCR conversion process, the method checks for errors that may be produced in the OCR processed document in block 210. Thereafter, a determination is made in response to whether errors are found in the OCR processed document. If errors are not found in the OCR processed document (210_No), the method goes to block 214.

In the alternative (210_Yes), the method moves to block 212 where it corrects errors generated from the OCR conversion process in block 208. The user may edit and correct the OCR processed results if necessary. Note that in certain applications, the method may not require the OCR processed results to be absolutely correct. For example, absolute accuracy is not required when the information is used only for indexing of the original document.

In block 214, the document is saved in text format, using either the OCR processed document from block 210 or using the user-corrected document from block 212. In block 216, the method transfers and stores the document in both the image format and OCR processed text format in a relational database, where the method uses the character information derived from the OCR conversion process for indexing. One example is a full-text indexing of the document. Upon completion of block 216, a user may apply a full-text search of the document in text format in the relational database or search for certain particular information contained in the document.

As shown in the method described above, the image format of the original document may include a special format, which can not be saved in the relational database directly through the conventional method of manual data entry. Thus, after the original document is scanned, an OCR conversion process is applied to recognize the character information in the scanned image. A user may manually edit the OCR generated text document to correct any errors if necessary. The original image document and the character information expressed in the document may be saved in a relational database as a record item, and the character information may be indexed. Using this method, each image format of the document can be recorded by one or more keywords, and the information contained in each document can be searched using a full-text indexing technique. As a result, not only does the method of the present disclosure preserve the visual information of the original document, it also saves time and effort required for storing such documents significantly.

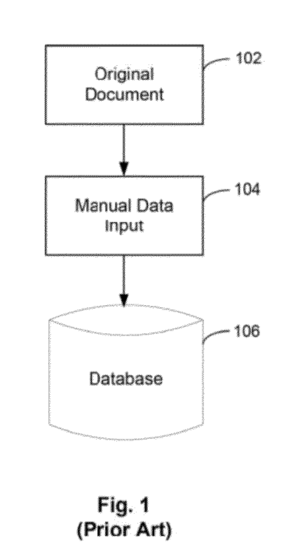

Comparing the conventional method described in FIG. 1 and the method described in FIG. 2, one may note that the conventional method requires manual data entry of the original document into a computer, which is tedious, time consuming, and does not capture all information contained in the original document. On the other hand, with the approach described in FIG. 2, digital input devices like digital camera and scanner are used to convert original documents from paper format to digital format efficiently while preserving information contained in the original document.

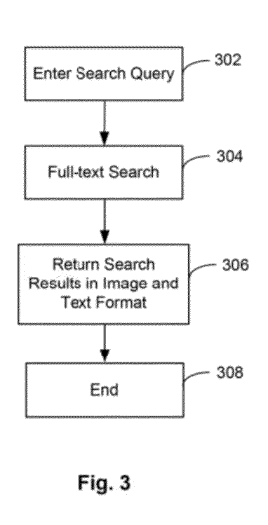

FIG. 3 illustrates a method for searching information from the relational database of FIG. 2 according to an embodiment of the present invention. In this example, the method starts in block 302 where the user enters a search query. Next the method conducts a full-text search in block 304 against the relational database, which includes documents stored in both text and image formats that are created and stored by the method described in FIG. 2. The full-text search is performed on the text version of the documents or on keywords associated with the document to generate search results that match the search query. In block 306, the method returns the search results that include documents in both image and text formats. The method ends in block 308.

Note that there are various approaches for capturing information as an image, including taking photos with a digital camera or scanning a paper document with a scanner. These devices are commonly available to users in today's business environment. It is beneficial for a user to be able to quickly capture information as images and process them in an efficient manner. For example, a user may conveniently take a picture of an advertisement on a billboard, scan a business card, or take a picture of meeting minutes. These image documents can be transferred to a computer in a variety of image formats such as .bmp, .gif, .jpg, .pcd, .pct, .pict, .pcx, .pdf, .png, .tga, .vda, .icb, .vst, .tidd, .psb, .pdp, .sct, etc.

According to embodiments of the present invention, a full-text search method is employed. In the full-text search method, a computer program sets up an index for each word in a document by scanning the whole document, and indicates the positions and the number of times a word appears in the document. When a search query is received, the search program can lookup in the previously established index according to a search algorithm, and provide search results to the user.

The full-text searching method may be implemented in different ways, such as searching by a keyword or searching by a phrase. The searching by a keyword approach sets up an index for each word in the document. In this case each phrase in the document may be broken up into a combination of words. For different languages, each keyword or phrase may have different meanings. Therefore, the search algorithm takes the meaning and context of the surrounding sentences into consideration. In addition, there are other differences between different languages that need to be resolved. For example, in a Western language like the English, each word is separated by a space. So the space and other special characters, for example punctuations, are used to identify the boundaries of words and phrases. While in an Eastern language like the Chinese, there is no space between words. Thus, font size, typesetting, and special characters (such as punctuations and spaces) are used to identify the boundaries of words and phrases. Searching by keyword sets up an index for each word, for example each semantic unit, in the document. The searching process is based on words, and may also add the capabilities to recognize synonyms.

According to embodiments of the present invention, an optical character recognition (OCR) conversion process is used. The OCR process may be regarded as a translation of images of text (by scanning or other optical input methods) into computer-editable text. The OCR process may automatically estimate, split, recognize, and convert different kinds of general presswork forms, achieving satisfying results on the comprehension of the forms. It can automatically analyze a document's layout, divide its sections and estimate the corresponding properties of headers, horizon lines, images and forms, as well as determine the recognition order. The recognition results can be saved as a new document which has a same display format (page setting) and layout as the scanned manuscript.

An automatic form inputting technique can automatically recognize not only the printed characters, letters, figures, but also handwritten characters, symbols, and figures. It promotes the efficiency of data entry for tables by saving time and effort for performing such tasks. This technique can change the recognition forms directly to commonly used document formats, such as .pdf, .html, .doc, and .pft. Also, it applies the automatic typeset analyzing on horizontal text, vertical text, and form text that are embedded in the image.

According to embodiments of the present invention, one application of the image-based data management system is to be used for storing, organizing, and accessing business cards.

In today's continuous expansion of the business social network as well as in business meetings, people exchange business cards frequently. Their business card collection has become larger and larger. It is important to be able to store, manage, and access such large business card collection in an efficient manner. Although there are some business card management software applications and tools currently available, for example Microsoft Outlook produced by Microsoft Corporation, but people typically enter the information on their business cards into Microsoft Outlook manually. This manual data input step is not only inefficient; it also loses some information contained in the business cards, such as a company's logo. The image-based data management system of the present invention is adapted to address these problems, and the system is also referred to as the business cards management system (BCMS).

In general, using the image-based data management system described above, a user may use commonly available devices such as digital cameras or scanners to capture images of the business cards and transfer them to a computer. These image documents can then be recognized by an OCR process, and each text field on the business card can be matched to certain categories of information such as a company's name, name of the person, address, email address, website, etc. Also, the OCR results may be revised, and the user may save the text fields as well as the images of the business cards into a relational database for subsequent full-text indexing and searching.

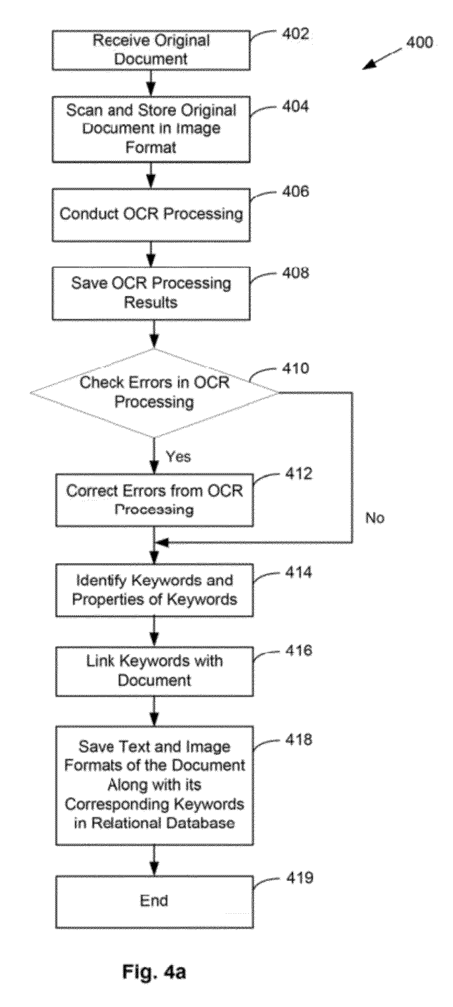

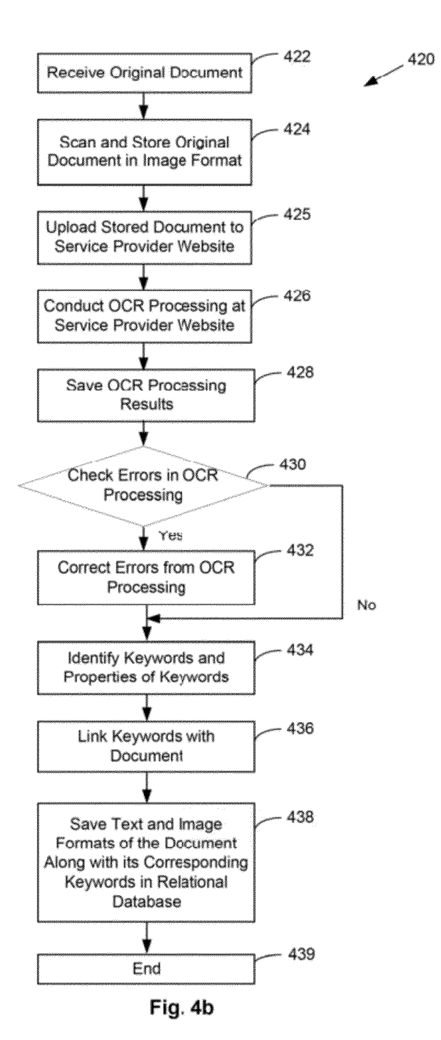

In one implementation, the BCMS system is a web-based software system. Each user can register its account on BCMS' website to download and install the client software for recognizing and uploading business cards (client software interface shown in FIG. 4A). Using the client software, the characters on the JPG document of the business card can be recognized, and the property of each text field can be setup in a visual equivalent grid mode. After revising the recognition results, the JPG document and the text field information can be uploaded into BCMS website's server. All these uploading information can be saved and indexed into a database for searching and managing.

The BCMS website provides the recognition function at the server end. Thus, the user does not need to download the client software, but only upload the image format of the documents onto the server. These documents can be recognized in the server end, and can be set and revised on the web-based operating platform. An advantage of web-based system is that a user can save his business cards information in the server, and avoid losing the information if his personal computer breaks down or if he loses his PDA. The information saved on the server can be shared between a user and his friends. Whenever or wherever the user may be, he may use an internet-capable device, for example personal computer, PDA, or mobile phone, to login to the BCMS website to manage and search his personal business cards. In addition, he may also share his business cards data in ‘Vcard’ format and send them to any other devices that support the ‘Vcard’ format.

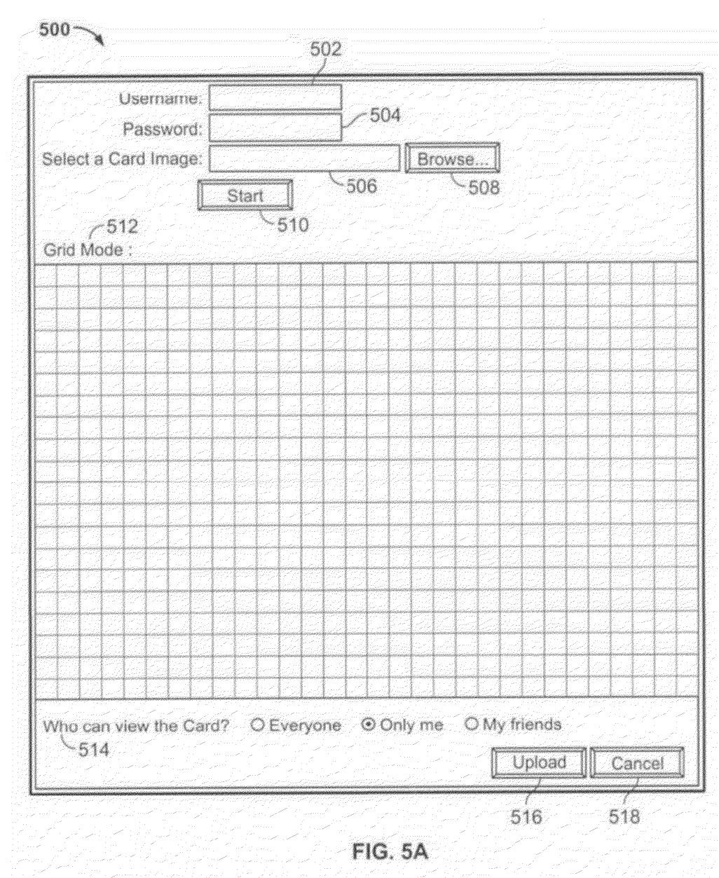

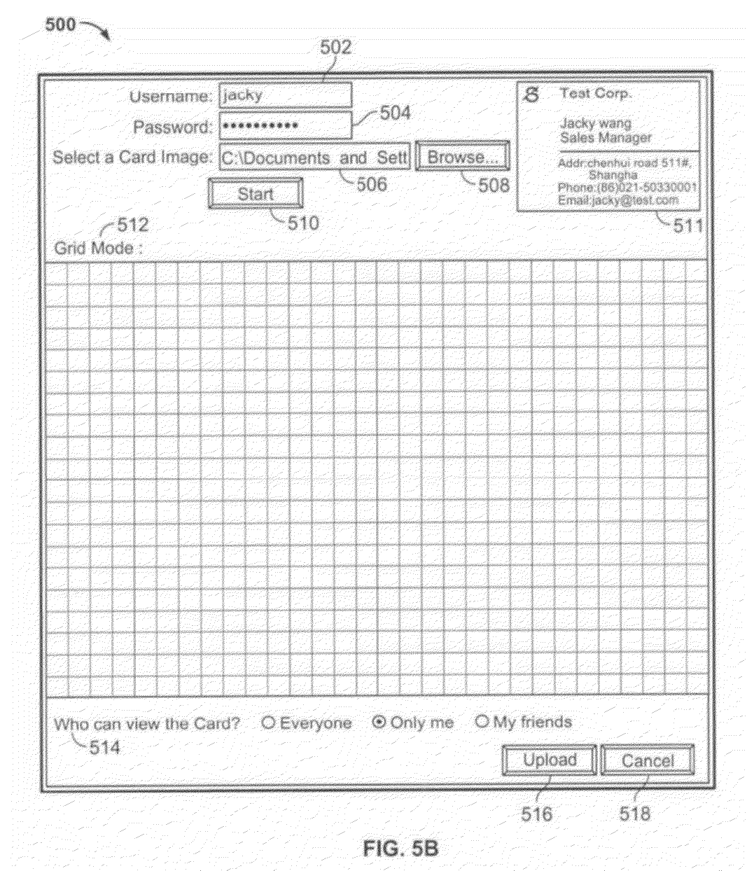

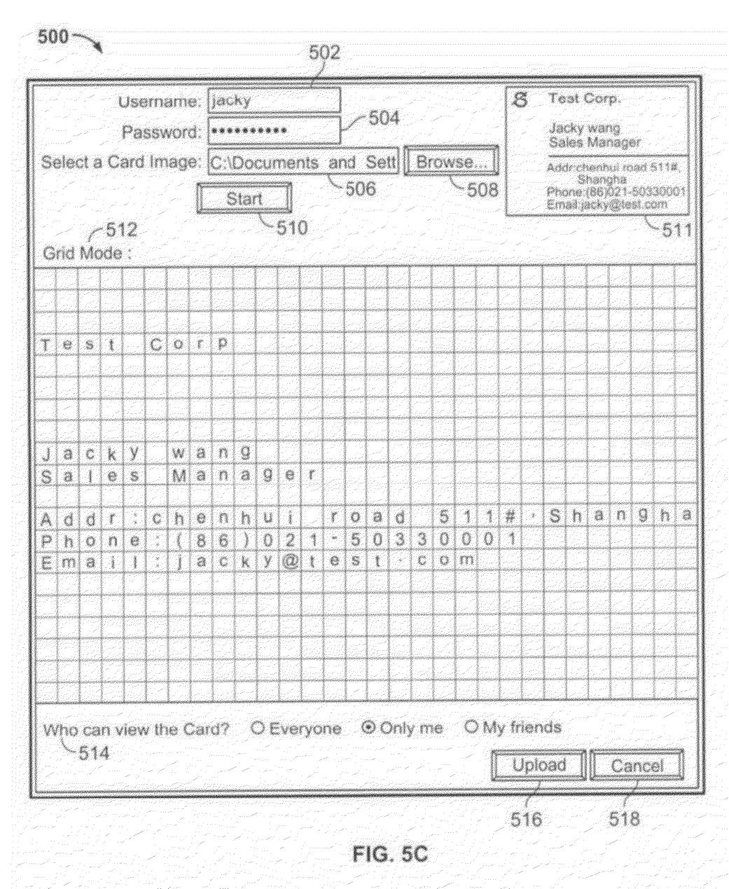

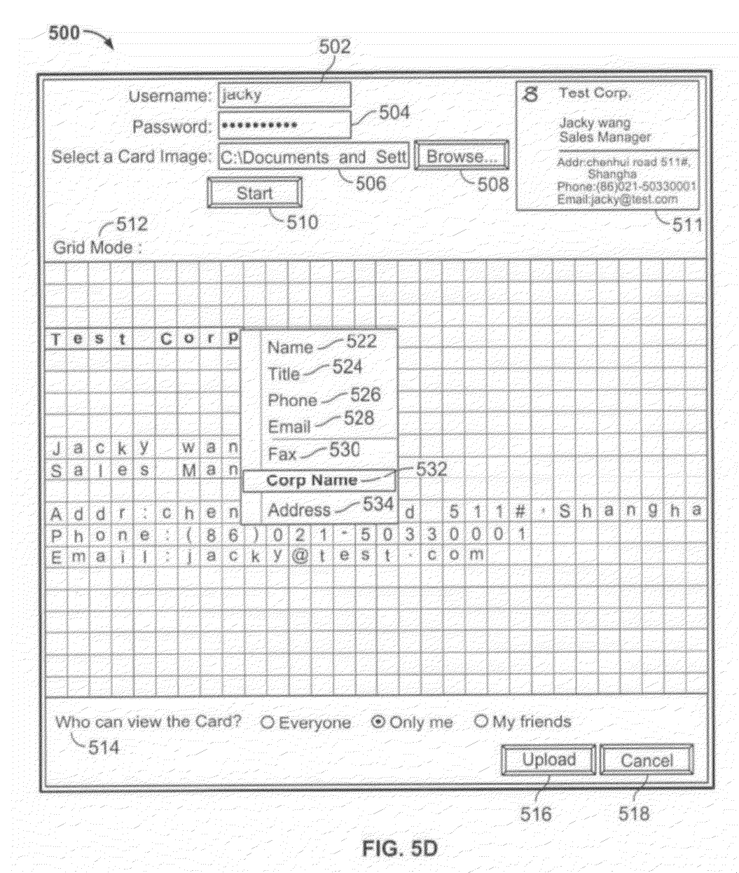

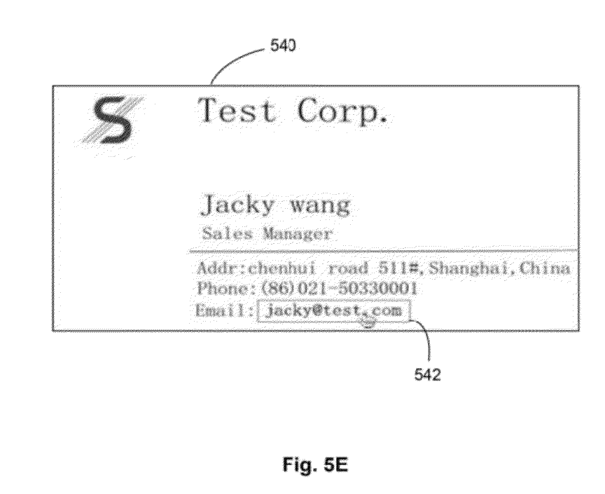

FIG. 4A illustrates an implementation of processing image-based data at a client site according to an embodiment of the present invention. As shown in FIG. 4A, an image-based document, such as information on a business card, can be stored, processed, organized, and accessed at a client site through the method 400. The method starts with receiving an original document in block 402 and thereafter, it moves to block 404 where the method scans and stores the original document to create an image of the document in an image format. In block 406, the method performs OCR processing of the scanned document to convert the document from an image format to a computer editable text format. In block 408, the method saves the OCR processing results from block 406 in a grid form. The grid form is shown in FIGS. 5A-5D and further discussed in their corresponding descriptions of the FIGS. 5A-5D.

In block 410, the method checks for errors in the OCR processed document created in block 406 and saved in block 408. A determination is made as to whether there are errors in the OCR processed document. If there are no errors found in the OCR processed document (410_No), the method moves to block 414. In the alternative, if there are errors found in the OCR processed document (410_Yes), the method moves to block 412 where the method corrects the errors created from the OCR processing.

In block 414, the method analyzes the OCR processed document and identifies keywords and their associated properties of the keywords. In block 416, the method links the document with the keywords and their associated properties. In block 418, the method saves both the text and image formats of the document along with the keywords of the document in a relational database. The stored information enables subsequent search of the document in the relational database with the keywords identified. The method ends in block 419.

FIG. 4B illustrates an implementation of processing image-based data at a service provider's website according to an embodiment of the present invention. Similar to the method shown in FIG. 4A, Image-based data can be recorded and processed at a service provider's website through the method 420. The method starts with receiving an original document in block 422 and thereafter, it moves to block 424 where the method scans and stores the original document to create an image of the document in an image format. In block 425, the method logins in to a service provider's website and uploads the stored original document in the image format to the service provider's website. In block 426, the method performs OCR processing of the scanned document to convert the document from an image format to a computer editable text format. In block 428, the method saves the OCR processing results from block 426 in a grid form. Examples of the grid form are shown in FIGS. 5A-5D and further discussed in their corresponding descriptions of the FIGS. 5A-5D.

In block 430, the method checks for errors in the OCR processed document created in block 426 and saved in block 428. A determination is made as to whether there are errors in the OCR processed document. If there are no errors found in the OCR processed document (430_No), the method moves to block 434. In the alternative, if there are errors found in the OCR processed document (430_Yes), the method moves to block 432 where the method corrects the errors created from the OCR processing.

In block 434, the method analyzes the OCR processed document and identifies keywords and their associated properties of the keywords. In block 436, the method links the document with the keywords and their associated properties. In block 438, the method saves both the text and image formats of the document along with the keywords of the document in a relational database. The stored information enables subsequent search of the document in the relational database with the keywords identified. The method ends in block 439.

FIGS. 5A-5E illustrate a method for storing, organizing, and accessing business cards according to embodiments of the present invention. FIG. 5A illustrates a user interface for organizing business cards according to an embodiment of the present invention. In this example, the user interface 500 provides a username field 502 and a password field 504 that may be used together for authenticating the user. A select a card image field 506 is provided where the user may enter a directory path to a business card file in the system. Alternatively, the user may use the browse button 508 to find a business card file in the system. The start button 510 activates the OCR process that reads the business card file in an image format and displays it in a grid mode 512 according to each character's position in the business card. The user interface further provides the user options regarding who may view the business card 514. For example, the user may select 1) everyone, 2) only me, or 3) my friends who are given the permission to be able to view the business card. In this example, the “only me” (also referred to as “owner only”) option is selected by the user. The Upload button 516 allows the user to upload a business card to a service provider's website, and the Cancel button 518 allows the user to cancel the operations that may have been performed on a particular business card and repeat the process.

FIG. 5B illustrates an example of the user interface of FIG. 5A being used according to an embodiment of the present invention. As shown in FIG. 5B, the user enters “jacky” in the username field 502, and a ten character password is entered in the password field 504. In addition, the user has provided a path to a business card, and an image of the business card is shown as item 511.

FIG. 5C illustrates an example of displaying a business card in grid mode according to an embodiment of the present invention. As shown in FIG. 5C, each character of the original business card is displayed in a grid according to its corresponding position in the business card. In the grid mode, the user may check for the correctness of the information contained in the grid, which is automatically created by the OCR process discussed in block 208 of FIG. 2 (block 406 of FIG. 4A or block 426 of FIG. 4B).

FIG. 5D illustrates a method of identifying keywords and corresponding properties the keywords according to an embodiment of the present invention. In the approach shown in FIG. 5D, a user may select certain text information, for example “Text Corp” as highlighted in FIG. 5D. Then, the user may right-click to select from a pull-down menu 520 a property that relates to the text being selected. For example, the corresponding properties of keywords in a business card may include Name 522, Title 524, Phone 526, Email 528, Fax 530, Corporation Name 532, Address 534, URL to website (not shown), etc. of the person named in the business card 511. In this example, the selected text “Test Corp” is the Corporation Name 532 of the business entity shown in the business card.

From FIG. 5A to FIG. 5D, after setting up the BCMS account's registration information in the client software and choosing the image, after the user clicks the ‘start’ button, the OCR software begins to recognize the characters in the business card and put them in the grid mode accordance with their original positions. Then the user can edit and revise the OCR results, also the user may use select certain characters and then right click to set up the property of the selected text using the pop-up menu. Using the grid mode environment, the user may be guided to input information in a convenient manner. After finishing the above procedures, the user can click the ‘upload’ button to upload the OCR results and the image file of the business card onto the BCMS server, or otherwise click ‘cancel’ to cancel the OCR results to start over again.

As discussed above, the method described in FIGS. 5A-5D may be applied to manage a user's business cards. In one approach, a user may use a digital camera or camera phone to take a photo image of a business card. The image file of the business card may then be transferred to a computer. Then, the user may use client application software to retrieve the information in the image file to a computer editable text format. The method can then put the recognition results in a grid, where each character occupies one space in the grid, and each character may be edited. The user has the opportunity to edit and revise the OCR results in the grid. In addition, the user is able to select characters in multiple spaces in the grid, and associate the selected characters with user-defined properties. Examples of user-defined properties may include name, title, company name, telephone number, email address, URL to website, etc. Then, the user may upload both text and image format of the business card, which will be stored onto the server. In the server, the business card information can be indexed for support of subsequent searching by the user.

FIG. 5E illustrates a method for establishing a hyperlink to certain content on a business card according to an embodiment of the present invention. When setting up a business card, the method may automatically create a hyperlink based on the text field's property entered by the user. For example, the method may automatically add a hyperlink 542 on the email address of the person listed in the business card 540. After the hyperlink 542 is created for the email address, the user may simply click the hyperlink 542 to invoke an email program if he wishes to send an email to the person listed on the business card. In this manner, it saves the user time and effort of manually entering the email address from a business card 540. In addition, the name of the company may be linked to the company's webpage. Thus if the user clicks on the name of the company on the business card, the corresponding URL of the company's webpage may be accessed by the browser. Similarly, the address of the company on the business card can be linked to an interne map application, such as the Yahoo Maps. Once the address is clicked, the browser opens automatically and its location can be shown on the Yahoo map. Also, an automatic-calling function can be added to the telephone and mobile numbers, once the phone numbers are chosen by the user, a phone calling program like SKYPE, net-meeting may be activated. As shown in the above examples, the insertion of automatic hyperlinks makes the business card more user-friendly and more accessible to the users.

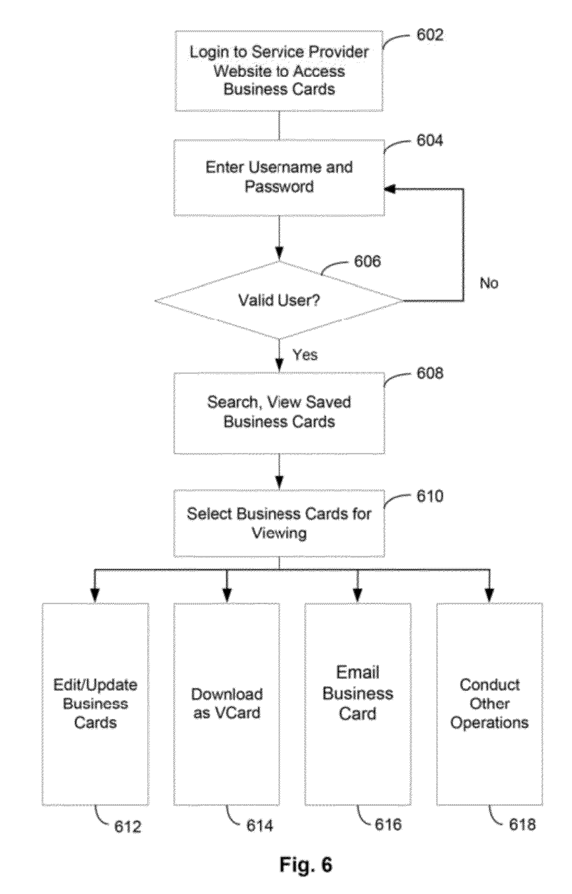

FIG. 6 illustrates a method for accessing business cards on a service provider website according to an embodiment of the present invention. In general, the user may access his business card management webpage on a service provider website at any time, from anywhere, and with any device, such as PDA, cellular phone, personal computer, etc. In the webpage, the user may search and view the business cards by keywords, and choose a specific business card to revise or edit and correct. The information may be retrieved in VCard format and transferred to Microsoft Outlook or other VCard-capable communication software and devices. The user can also share the business card with his friends by forwarding the VCard document to them via electronic messages.

As shown in the exemplary flow diagram of FIG. 6, the method starts in block 602 where a user logins to a service provider website to access business cards information. In block 604, the method prompts the user to enter his username and password for authenticating the user. In block 606, a determination is made as to whether the username and password entered in block 604 correspond to a valid user. If the username and password entered match to a valid user (606_Yes), the method continues in block 608. In the alternative, if the username and password entered do not match to a valid user (606_No), the method repeats block 604 and 606 to prompt the user to re-enter his username and password for verification.

In block 608, after the user has been authenticated, the method allows the user to search and view previously saved business cards in a database managed by the service provider. In block 610, the method may enable the user to select business cards for viewing. After viewing a business card, the method allows the user to edit/update the business card 612, download the business card as a VCard 614, email the business card as a VCard 616, or conduct other operations with the business cards 618.

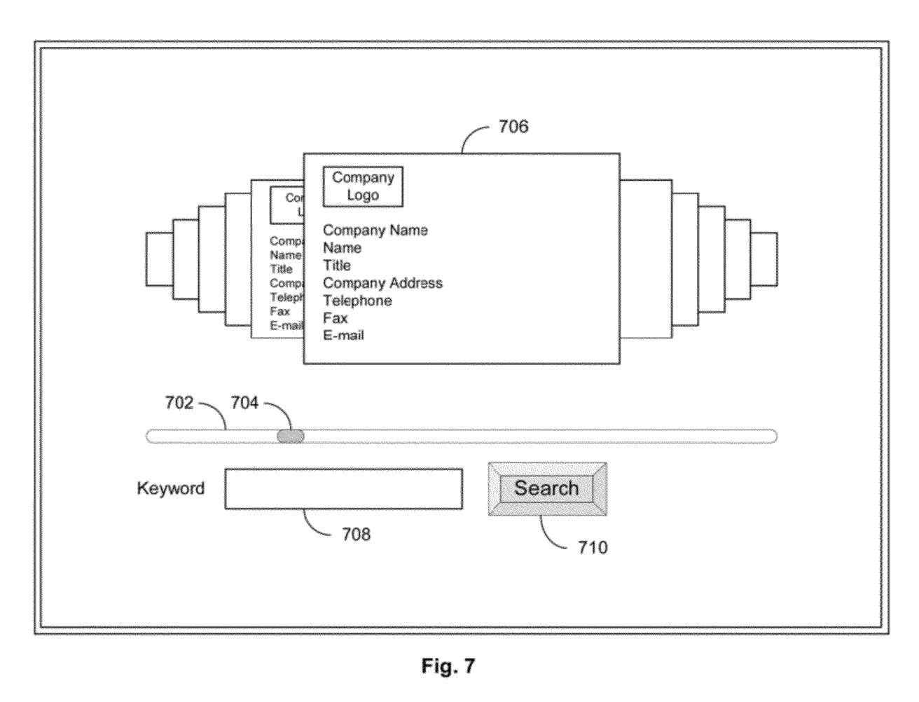

FIG. 7 illustrates a method for viewing saved business cards according to an embodiment of the present invention. In browsing and searching business cards, a Rolodex view that creates an animated enlargement effect may be made available to the user. In one embodiment, the user may drag a scroll bar 704 along a scroll line 702. When the scroll bar is dragged from right to left, the business cards rotate from right to left. On the other hand, when the scroll bar is dragged from left to right, the business cards rotate from left to right. The user may also search for business cards by entering keyword(s) in the search box 708, and then press the search button 710. During a search, a display of the business cards being rotated (and being searched) is shown to the user. When a business card that meets the searching criteria is found, the business card is displayed to the user in focus.

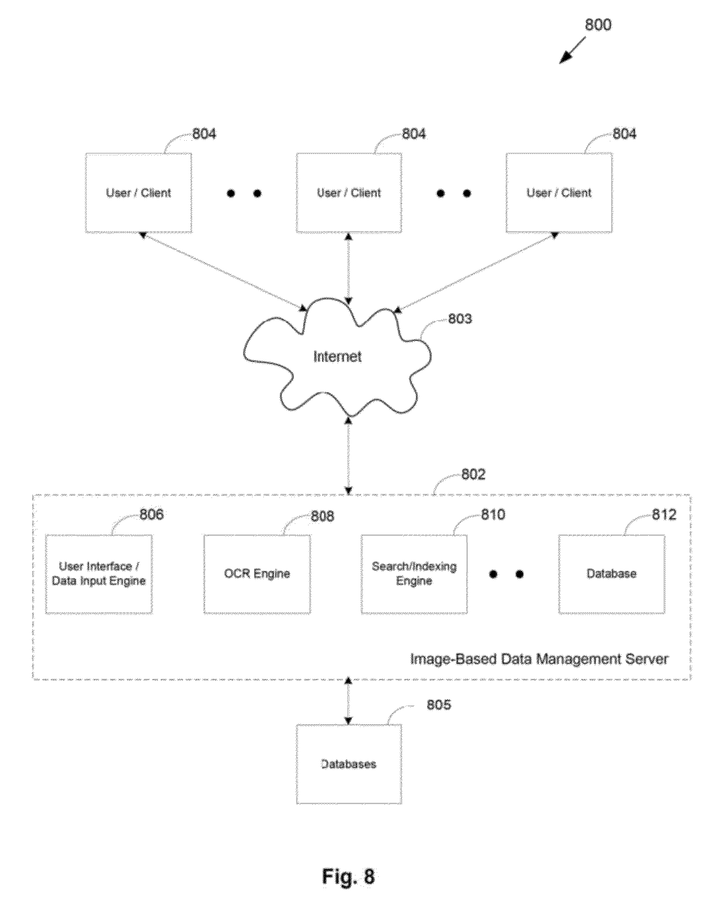

FIG. 8 illustrates a system for organizing business cards according to an embodiment of the present invention. The system 800 includes one or more Image-based data management servers 802, and one or more clients 804. The servers 802 interface with the clients 804 via the Internet 803. The servers further include a plurality of application engines, for example, a user interface/data input engine 806, an OCR engine 808, a search/indexing engine 810, and a database 812. An application engine is a computer system implemented with different hardware and software for a specific application, such as the applications shown in FIG. 8. The application engines implement Web 2.0 functionalities using a combination of HTML, CSS, JavaScript and “Asynchronous JavaScript and XML” (AJAX).

In particular, JavaScript is used to create, monitor, change and destroy objects and change the state of various objects, in addition to keeping track of browser behavior changes initiated by the user. For example, when a user starts dragging a business card image in the browser window, the browser fires “mouse down” and “mouse move” events which are captured by the JavaScript, and an object is created to handle the event. The object is effectively a copy of the original business card image, and the copy of the image is being moved around. When the object is put into the a Rolodex view, it is added to the Rolodex view controller object, which monitors this new object being added to it and continues to keep track of the object. Similarly, when the user removes a business card from the Rolodex view, the browser fires a “delete” event which is captured and result in the removal of the business card from the Rolodex view. In other words, each object has states, and such states are created and modified in response to user initiated changes (events) to the browser behavior. In other approaches, JavaScript, Object-C, Flash/ActionScript, MySQL, Linux, PHP may be used to implement the solutions of the present disclosure.

In addition, the servers 802 may include the databases, processors, switches, routers, interfaces, and other components and modules. Each of the servers 802 may comprise one or more servers, or may be combined into a lesser number of servers than shown, depending on computational and/or distributed computing requirements. The servers 802 may be located at different locations relative to each other. The databases may also be separately connected to the servers 802. There may be more or fewer than two databases, depending on computational and/or distributed computing requirements. The databases may be located at different locations relative to each other and the servers 802.

Each of the clients 804 may be a general-purpose computer, such as a personal computer, having a central processing unit (CPU), a memory, an input device, an output device, and a display. Other computer system configurations, including Internet appliances, hand-held devices, wireless devices, portable devices, wearable computers, cellular or mobile phones, portable digital assistants (PDAs), multi-processor systems, microprocessor-based or programmable consumer electronics, set-top boxes, network PCs, mini-computers, and the like may also be implemented as the clients 804. Each of the clients 804 may also implement analog and digital baseband circuitry, power management circuitry, radio frequency (RF) transceiver, and battery interface and charging circuitry. Clients 804 may include one or more applications, program modules, and/or sub-routines. As an example, clients 804 may include a browser application (e.g., Internet Explorer, etc.) and a graphical user interface (GUI) to access websites and web pages provided by the servers 802 and data stored at the databases 803. Clients 804 may be remote from each other, the servers 802, and/or the databases 805.

The network 803 is a communications network, such as a local area network (LAN), a wide area network (WAN), or the Internet. When the network 803 is a public network, security features (e.g., VPN/SSL secure transport) may be included to ensure authorized access within the system.

As described above, the process of monitoring and updating states of an object is event driven. When a user performs a specific action, JavaScript that runs in the background determines the exact browser event that has been initiated according to a set of user cases. For example, if the user clicks outside of a business card and drags, that action is interpreted as the intent to draw a selection rectangle. Similarly, if the user clicks directly on an image and starts to move by a distance greater than five pixels, that action is interpreted as a drag. Then, the JavaScript starts to monitor the mouse movement and attaches the business card images to the cursor at that point. While moving the cursor, the JavaScript updates the attached images' positions and waits for the user to release the image. Upon the images being released, the JavaScript determines the location of the cursor within the browser window. If the images are dropped on the Rolodex view, they are appended alongside the other images in the Rolodex view. If the images are dropped on an invalid drop target, a reset action is initiated and the images are snapped back to their original locations. While the user is dragging thumbnail images, the JavaScript monitors where the cursor is, and determines whether it is over a valid drop target or an invalid drop target. In the case that the cursor is over a valid drop target, the JavaScript would cause the valid drop target to be highlighted, providing a positive feedback to the user. When the cursor moves out of the valid drop target, the JavaScript would deactivate the highlighted area. This series of events is also referred to as the “hover” effect.

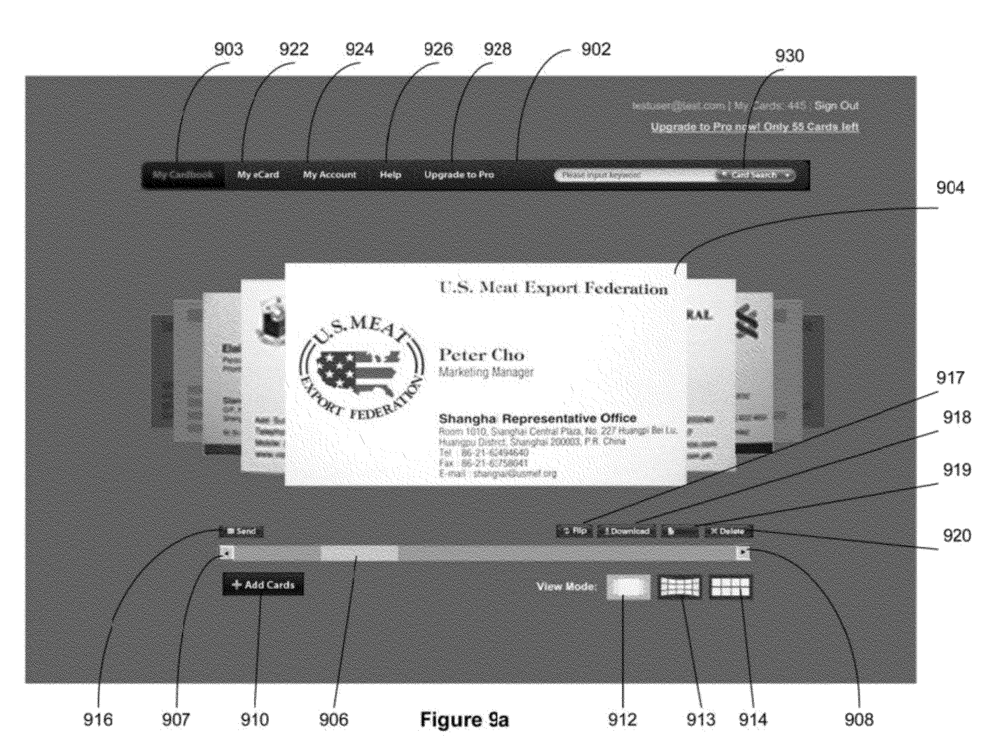

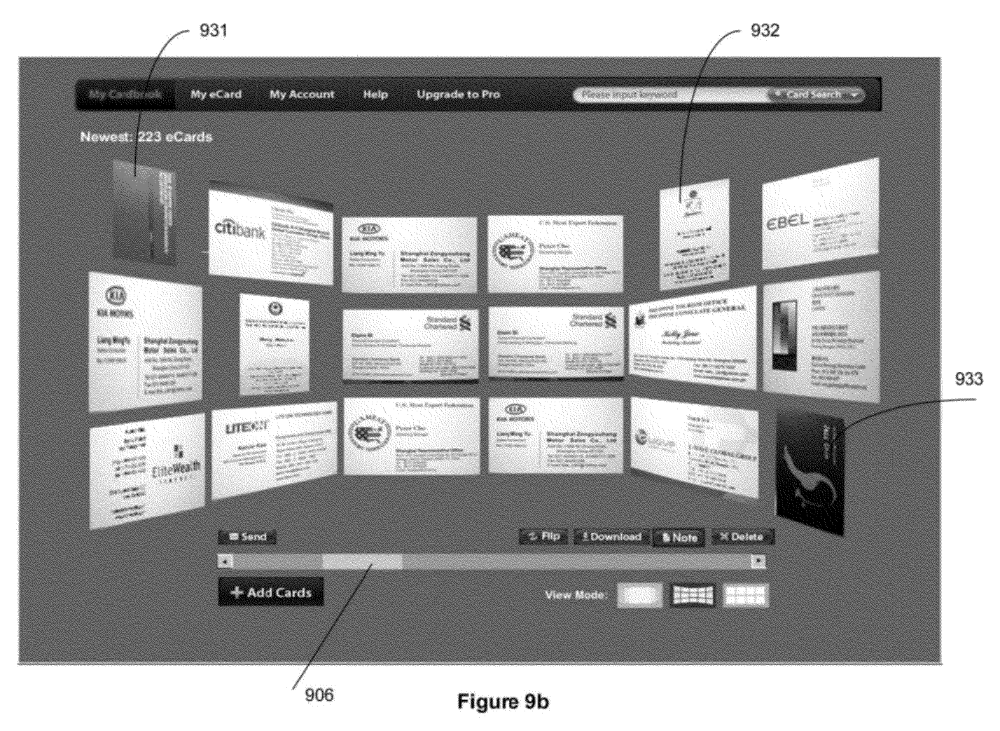

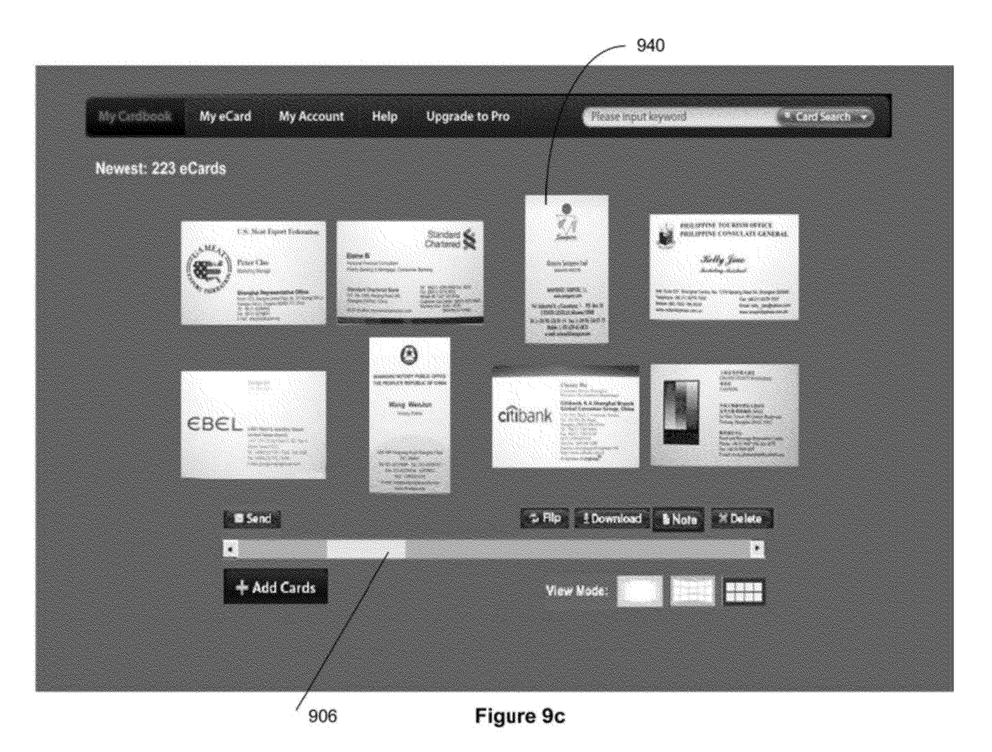

FIGS. 9A-9C illustrate methods for managing business cards according to embodiments of the present invention. In one implementation, the system may be implemented as a web 2.0 portal that provides services and management tools for its customers. After a customer is registered as a member, she may upload business cards to her account in the portal. As described above, the system forms an eCard for each business card uploaded, where the eCard preserves the original design of the business card and at the same time provides a link to its corresponding digital contents stored in a relational database. As shown in FIG. 9A, a user may use the pull-down menu 902 to manage and organize her business cards. When the user clicks on My Cardbook 903, she has a choice of three different view modes, namely rolodex view, 3-D view, and 2-D view, with the default set to the rolodex view 904 which is shown at the center of FIG. 9A.

FIG. 9A illustrates a method for organizing business cards in a rolodex fashion according to an embodiment of the present invention. In this example, the user may use a slider bar 906 to rotate and select a particular business card to the front for viewing. To do so, the user may simply drags the slider bar to the left or to the right in searching for a business card of interest. Alternatively, the user may also use the two arrows (one left pointing and one right pointing) at the end of the slider bar to move the rolodex of eCards forward or backward one card at a time. To add a business card to the deck, the user may simply click on the Add Cards button 910 and follow the instructions to add a card. If the user prefers a difference mode of viewing her business cards, she may click on one of the view modes: rolodex view 912, 3-D view 913, or 2-D view 914 to navigate to any view mode of her choice.

In addition, the Send button 916 enables the user to send an eCard to her friends. The recipient may view the content of the eCard via the email. The Flip button 917 enables the user to flip the eCard and view the information on the back of the eCard. On the back of the eCard, the user may include video, audio, images, memos, and links to other web sites and web pages. The Download button 918 allows the user to download an eCard to a location of her choice, such as her own personal computer. After downloading the eCard, she may send the eCard via commercial communication tools such as MSN, AOL, or Yahoo! Messenger to other recipients. The Note icon 919 allows the user to add notes to any eCard of her choice. The Delete button 920 allows the user to delete any eCard of her choice.

In addition, the pull-down menu further includes: 1) a My eCard tab 922 for the user to modify and update her own eCard (note that the user may have multiple eCards used for different purposes); 2) a My Account tab 924 for the user to view and manage the status of her account; 3) a Help tab 926 for the user to obtain help while using the portal; and last but not least, a Upgrade tab 928 for the user to upgrade to change to a different level of service. Furthermore, the menu bar includes a Card Search tab 930 where the user may enter key words to search for certain eCards of interest. In another approach, the user may also conduct a search based on the time period an eCard was added to the deck of business cards in My Cardbook.

FIG. 9B illustrates a method for organizing business cards in a three-dimensional manner according to an embodiment of the present invention. The tabs in the control bar (My Cardbook, My eCard, My Account, Help, Upgrade, and Card Search), the control buttons (Add Cards, Send, Flip, Download, Note, Delete), and the view modes (rolodex view, 3-D view, and 2-D view) function the same as described in association with FIG. 9A. In the example of FIG. 9B, a 3-D view of a portion of the business cards are shown. In one implementation, each eCard is shown in its most natural orientation. For example, some eCards are shown in the landscape format, while other eCards (cards 931, 932, and 933) are shown in the portrait mode. In this example, the user may use the slider bar 906 to slide a group of eCards to the window of display, and thus select particular cards of interest for viewing. To do so, the user may simply drags the slider to the left or to the right along the slider bar 906. Alternatively, the user may also use the two arrows (one left pointing and one right pointing) at the end of the slider bar to move other eCards into the window of the 3-D view by clicking on either the left arrow or the right arrow respectively.

FIG. 9C illustrates a method for organizing business cards in a two-dimensional manner according to an embodiment of the present invention. Similarly, the tabs in the control bar (My Cardbook, My eCard, My Account, Help, Upgrade, and Card Search), the control buttons (Add Cards, Send, Flip, Download, Note, Delete), and the view modes (rolodex view, 3-D view, and 2-D view) function the same as described in association with FIG. 9A. In the example of FIG. 9C, a 2-D view of a portion of the business cards are shown. In one approach, each eCard is shown in its most natural orientation. For example, some eCards are shown in the landscape format, while other eCards (e.g. card 940) may be shown in the portrait mode. In this example, the user may use the slider bar 906 to slide a group of eCards to the window of display, and thus select particular eCards of interest for viewing. To do so, the user may simply drags the slider bar to the left or to the right along the slider bar 906. Alternatively, the user may also use the two arrows (one left pointing and one right pointing) at the end of the slider bar to move other eCards into the window of the 2-D view by clicking on either the left arrow or the right arrow respectively.

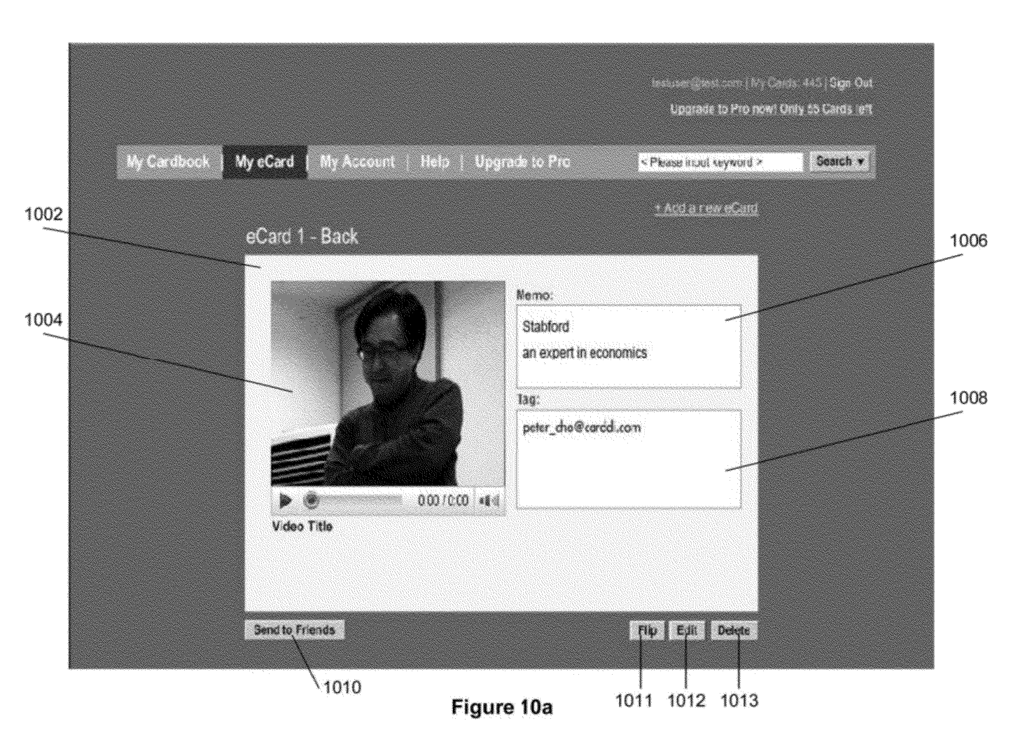

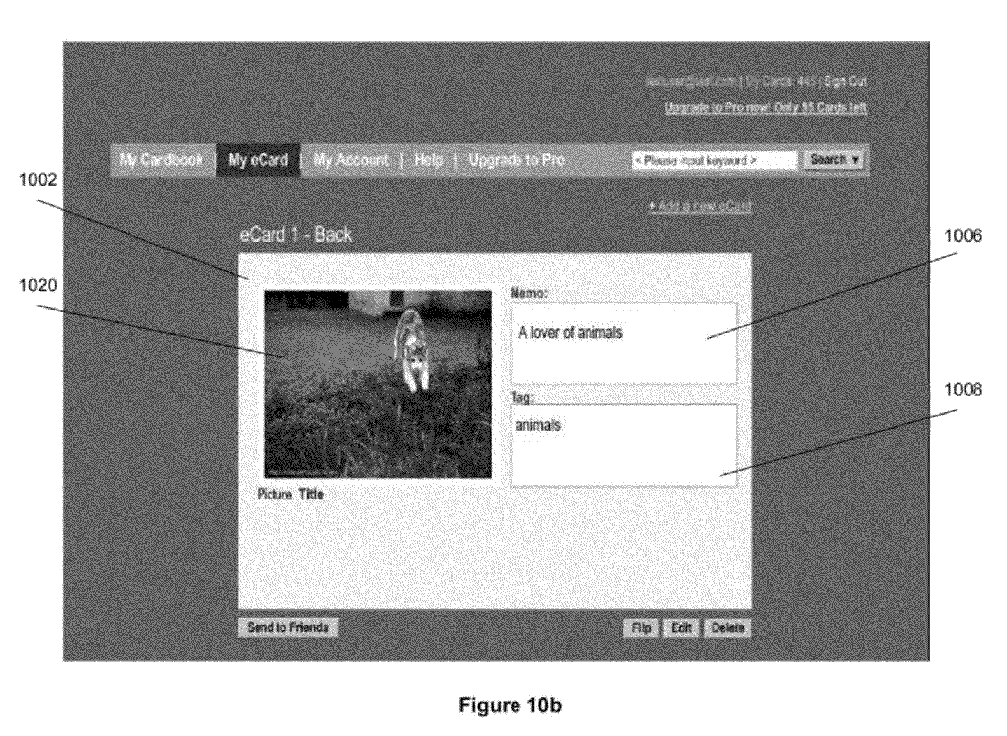

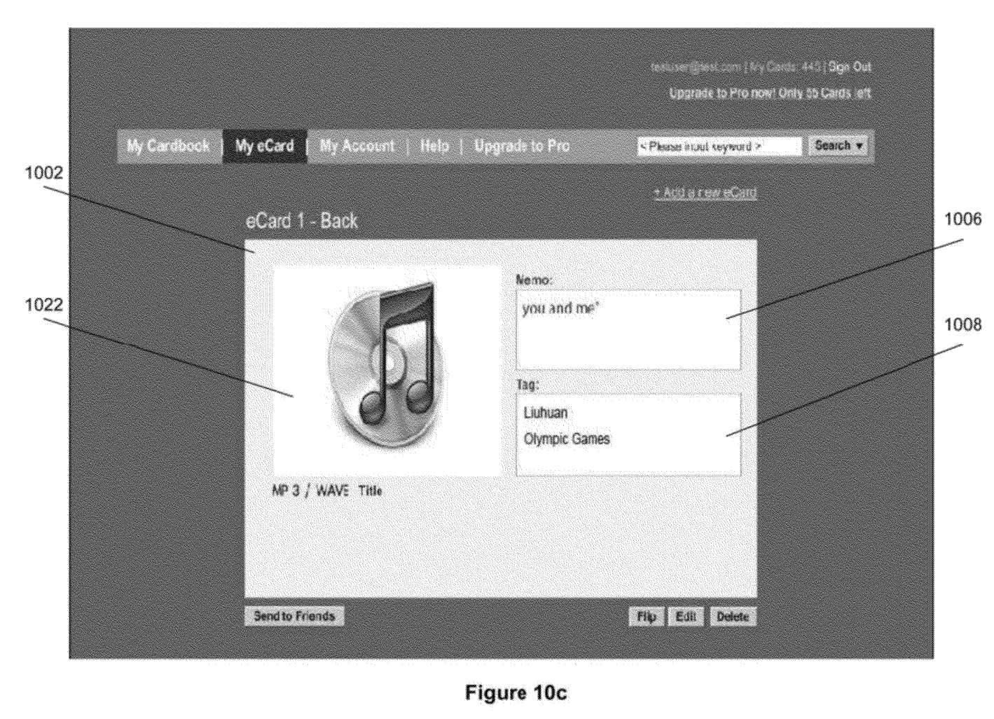

FIGS. 10A-10C illustrate methods for using back of a business card according to embodiments of the present invention. In particular, FIG. 10A illustrates a method for managing information about a business card according to an embodiment of the present invention. When a user clicks the Flip button 917 (FIG. 9A), the back of the eCard 1002 is displayed. In other embodiments, when the user clicks the Flip button 917, both the front and back of the eCard may be displayed. In the back of a business card, various tools are provided to enable users to better manage information associated with the business card. Using the information provided in the back of the business card, the user can better communicate with the person listed in the business card, who is Peter Cho in this example. In the example shown in FIG. 10A, a video clip 1004 may be provided to remind the user or tell others more about Peter Cho. In addition, the user may keep a memo 1006 about Peter Cho. In this example, the user put down “Stanford” which indicates the university Peter Cho graduated from, and “an expert in economics” which indicates the area of Peter Cho's expertise. In other embodiments, personal and professional information about Peter Cho may be includes, such as information about his hobbies, his family, his company, or his professional associations, etc. Furthermore, the user may also keep a tag 1008 about Peter Cho. Here, the user put down peter cho@carddi.com, which may be Peter Cho's personal email address. In other embodiments, links to Peter Cho's personal web page, Facebook account, or LinkedIn account may be used as a tag for guiding the user to more information about Peter Cho.

The user may send the above information to her friends simply by clicking the Send to Friends button 1010. The user may click the Flip button 1011 to return to the front of the eCard. The user may edit the contents of the Memo, Tag, or change to a different video clip by clicking the Edit button 1012 and follow the interactive instructions. Also, the user may delete the contents of the Memo, Tag, or remove the video click by clicking the Delete button 1013 and follow the interactive instructions.

FIG. 10B illustrates another method for managing information about a business card according to an embodiment of the present invention. The control buttons (Send to Friends, Flip, Edit, and Delete) function in the same way as described in FIG. 10A. In this example, a picture of Peter Cho's favorite pet 1020 is shown in the back of the eCard. The associated memo describes Peter Cho as “A lover of animals”, and the tag provides links to “animals” websites Peter frequently visit.

FIG. 10C illustrates yet another method for managing information about a business card according to an embodiment of the present invention. Similarly, the control buttons (Send to Friends, Flip, Edit, and Delete) function in the same way as described in FIG. 10A. In the example shown in FIG. 10C, an audio tile of Peter Cho's favorite music 1022 in the form of an MP3/wave format is included in the back of the eCard. The associated memo describes Peter Cho's favorite song “You and Me”, and the tag provides links to Peter's favorite artist “Liuhuan” and websites “Olympic Games” where the user may get more information about the artist and the song.

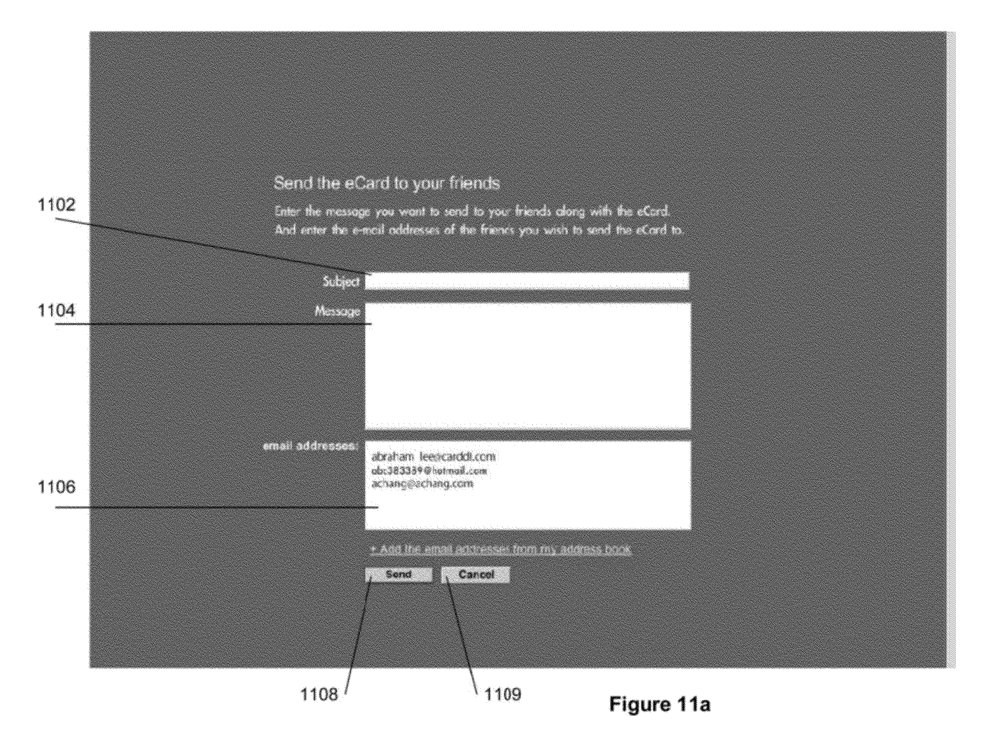

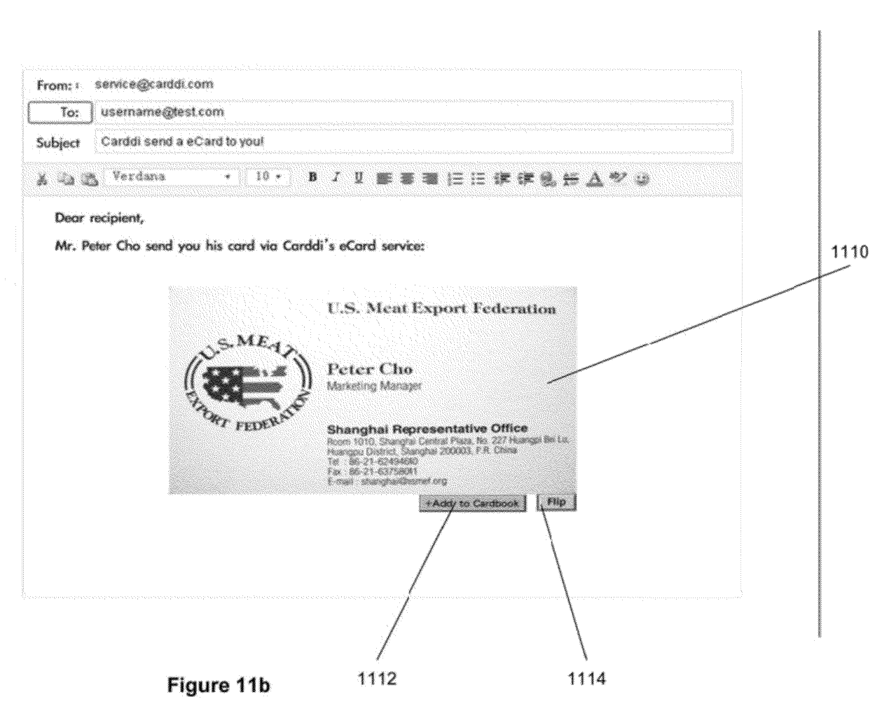

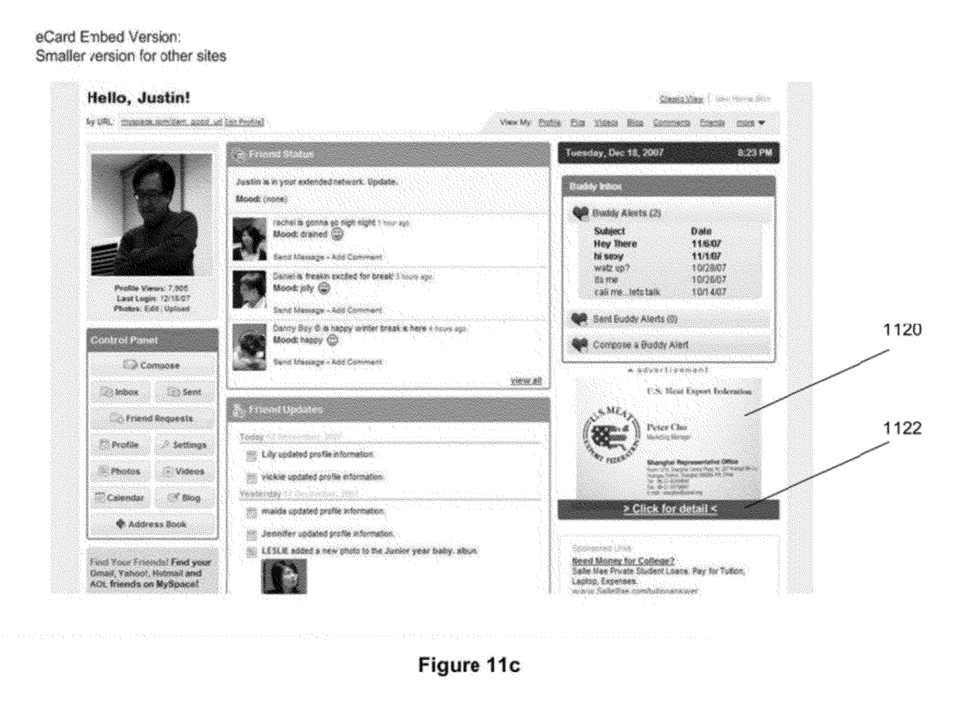

FIGS. 11A-11C illustrate methods for communicating information on a business card according embodiments of the present invention. By clicking on either the Send button 916 (FIG. 9A) or the Send to Friends button 1010 (FIG. 10A), the user may be able to sharing an eCard to a destination of her choice either via a web interface or via an email application. Specifically, FIG. 11A illustrates a method for sharing a business card via a web interface according to an embodiment of the present invention. As shown in FIG. 11A, the user may enter a title of the message in the Subject area 1102, a body of the message in the Message area 1104, and recipients email addresses in the Email Addresses area 1106. After a message is composed, the user may click the Send button 1108 to send the message. If the user would like to discard a message, she may simply click the Delete button 1109 to delete the message.

FIG. 11B illustrates a method for sharing a business card via an email according to an embodiment of the present invention. As shown in FIG. 11B, a thumbnail of the eCard 1110 is sent via in an email application. Upon receiving the eCard, a user may add the eCard to her book of eCards by clicking the Add to Cardbook button 1112. The user may also View the back of the eCard by clicking on the Flip button 1114. FIG. 11C illustrates a method for communication information of a business card via a webpage according to embodiments of the present invention. In this example, the eCard 1120 may be displayed on a webpage and viewers may be able to obtain details about the eCard by clicking the “click for detail” link 1122 and download the eCard by following the interactive instructions. In other embodiments, an URL or serial number may be assigned to each eCard in a Cardbook. Using the assigned URL or serial number, a user may access and view an eCard from any website on the Internet.

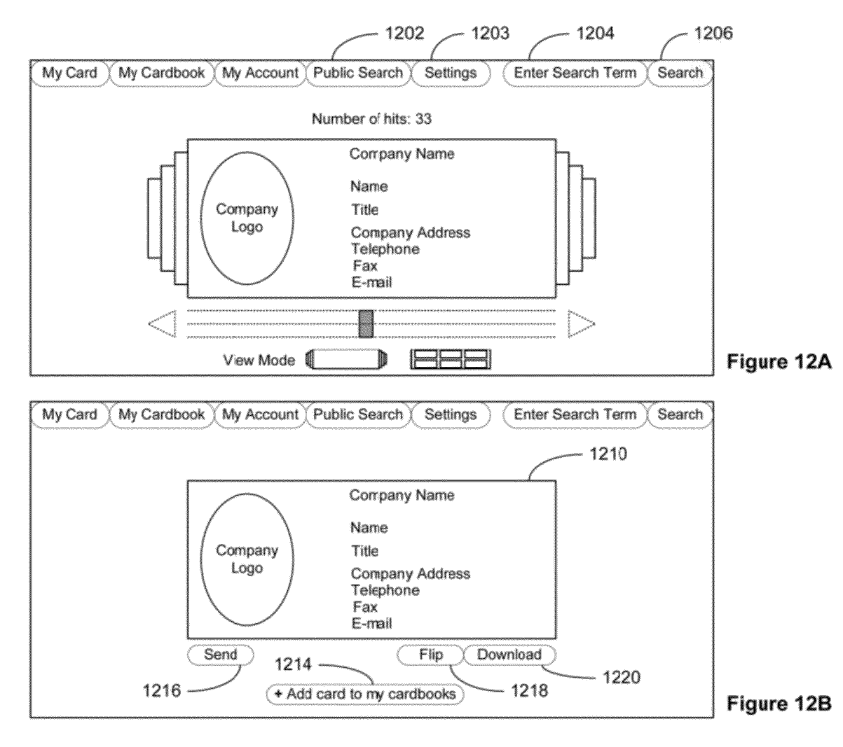

FIGS. 12A-12B illustrate methods for conducting a public search of business cards according to embodiments of the present invention. As shown in FIG. 12A, a user may click on the public search 1202 button to initiate a search of the business cards database where other users have voluntarily put up their business cards for access according to privacy settings assigned to the business cards. Note that the user may use the Settings button 1203 to set the privacy settings of his business cards. The privacy settings may include multiple security levels, such as private, members-only, user-defined-group-only, and public. For example, with a private setting, only the user may have access to the business card. With a members-only setting, only members of a predetermined organization, such as employees of a company, can have access to the business card. With a user-defined-group-only setting, only the user preapproved members of a group may have access to the business card. With the public setting, the general public may have access to the business card.

The user may enter a search term in the box 1204 and press the Search button 1206 to conduct a keyword search. For example, the user may be interest to find people from the city of Shanghai, or to find owners of a BMW automobile. Note that, each user has the option to determine whether to make his/her business card available for public to view and search. For users who want to keep their privacy, their business cards would not be available for public search. On the other hand, for users who want to promote themselves or their businesses, they may choose the option to allow the public to view and search the contents of their business cards. After the search, the number of hits is shown on top of the search results, which is 33 in the example of FIG. 12A. The user may use the left or right arrow, or drag along the slider bar (shown as three dotted lines) to view each business card containing the search terms. The user may also select between the rolodex or planar viewing modes.

In FIG. 12B, the user has selected a particular business card 1210 from the search results for viewing an enlarged image. He may add the card to his business card books using the Add card to my cardbooks button 1214. Also, he may use the send button 1216 to send the business card via email, or use the download button 1220 to download the business card to his computer. In addition, the user may use the flip button 1218 to view the back side of the business card for additional information.

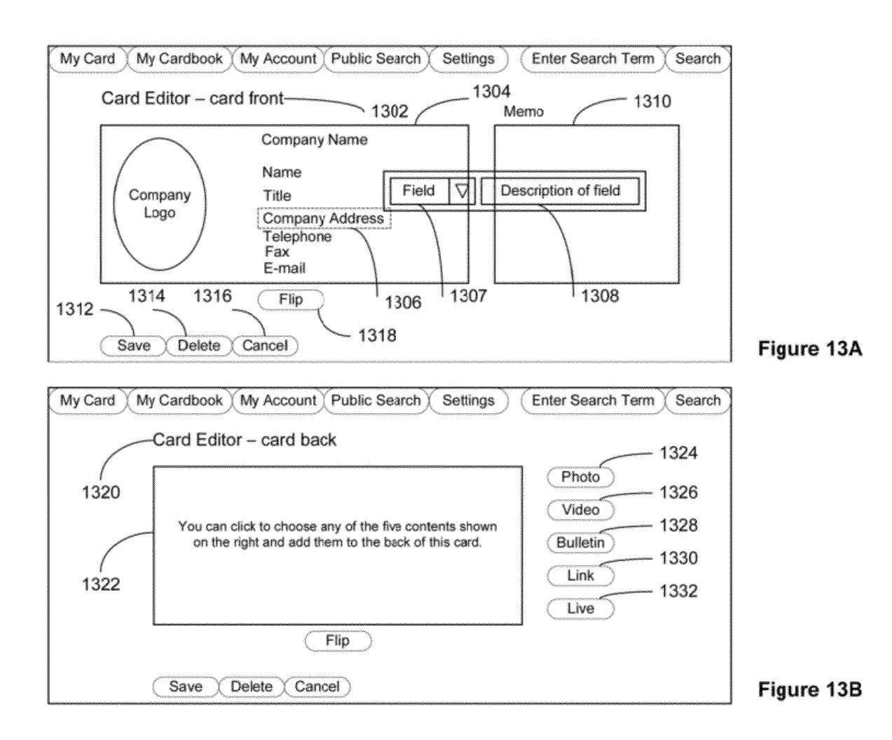

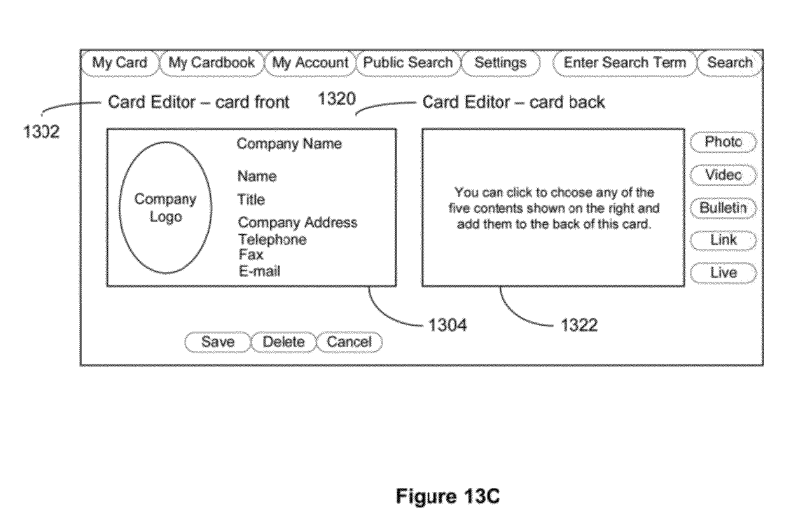

FIGS. 13A-13C illustrate methods for editing a business card according to embodiments of the present invention. In the example shown in FIG. 13A, a user may edit the front of a business card indicated as Card Editor—card front 1302. The business card 1304 has been processed as described in FIG. 2. The user may select any field on the business card for editing. In this example, the field company address 1306 is selected. Once a particular field on the business card is highlighted (indicated by the dotted line of 1306), a pop-up window is displayed to provide the user additional choices for editing. For example, the user may choose to change the selected field to another field 1307, and provide information for the field selected in the box 1308. In addition, a memo 1310 is provided with the business card, where the user may write down notes that may remind the user about the person described by the business card. For example, the user may tag the business card with information such as “New York Auto Show” to indicate a particular conference the user met the person in the business card. The user may also tag the business card with information such as “2008 New York Auto Show” to indicate the particular year and event where the user met the person in the business card. With such information tag to the business card, the user may search for this business card using the name of the conference “New York Auto Show” and further refine his search using the year “2008”. After modifying the business card 1302, the user may choose to save the changes, delete the changes, or cancel the changes by using the Save button 1312, Delete button 1314, or Cancel button 1316, respectively. During editing of the business card, the user may also use the Flip button 1318 to turn to the back side in case he needs any information from the back of the card. In other embodiments, the user may select any field on the business card, including the image of the company logo or a photo of the person associated with the business card, and save (copy and paste) it in another document.

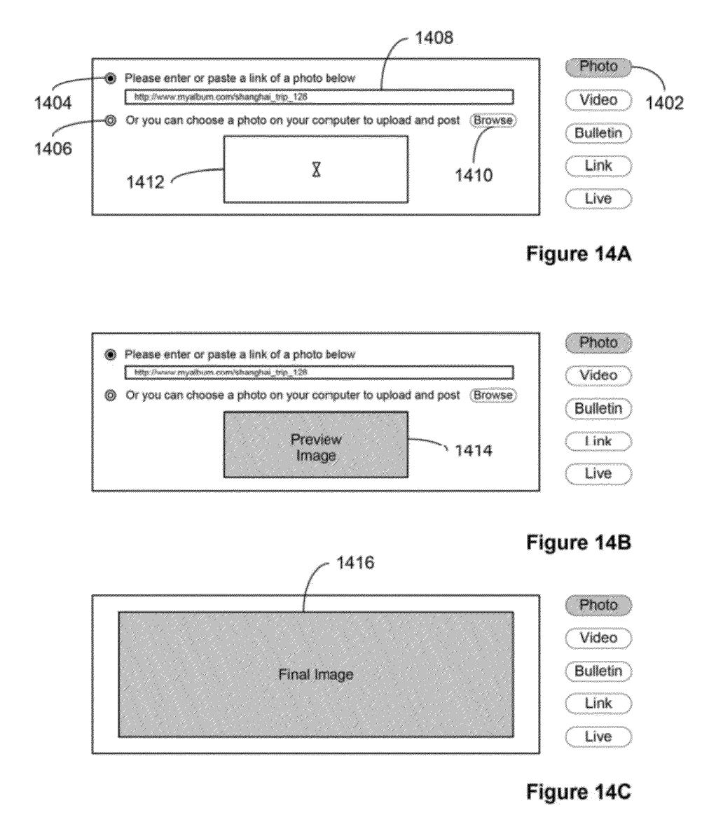

In FIG. 13B, the user may edit the back of a business card indicated as Card Editor—card back 1320. A blank space is provided and within which a message is display to remind the user that he may choose any of the contents shown on the right and add such contents to the back of the business card 1322. In particular, five buttons, namely Photo 1324, Video 1326, Bulletin 1328, Link 1330, and Live 1332 are provided to assist the user to add contents in each of the categories. Note that the user may choose to attach any combination of contents to the back of the business card by using the five buttons shown. Adding contents to each of the photo, video, bulletin, link, and live categories are further described in FIGS. 14-18 respectively.

In the exemplary FIG. 13C, both the front and back of the business card, and the headings Card Editor—card front 1302 and Card Editor—card back 1320 are displayed to allow the user to the front of the business card 1304 and the back of the business card 1322 on the same display. This approach eliminates the need to flip the business card back and forth when editing either the front or back of the business card. Similarly, after modifying either the front or the back of the business card, the user may choose to save, delete or cancel his changes by using the Save, Delete or Cancel buttons respectively.

FIGS. 14A-14C illustrate methods for attaching photos to a business card according to embodiments of the present invention. For simplicity, only information associated with the space 1322 and the five buttons 1324-1332 of FIG. 13B are shown. As shown in FIG. 14A, a user may initiate the method of attaching a photo by clicking the Photo button 1402. During the process of attaching the photo, the Photo button 1402 remains to be highlighted to indicate to the user the particular task he is performing. In the display, the messages “Please enter or paste a link of a photo below” and “Or you can choose a photo on your computer to upload and post” are shown to the user. If the user chooses to enter or paste a link of a photo, he selects this option by clicking the circle 1404 (as shown) and then enters a link of a photo, for example http://www.myalbum.com/shaghai_trip_128, in the space 1408. Alternatively, if the user chooses a photo on his computer to upload and post, he would click on the circle 1406, and then use the Browse button 1410 to select a photo from his computer to upload and post. An indicator is shown in the space 1412 to inform the user to wait for the photo to be uploaded. In FIG. 14B, once the photo is uploaded, a preview image 1414 is shown to the user. After the user approves the preview image 1414, a final image 1416 is attached to the business card as shown in FIG. 14C.

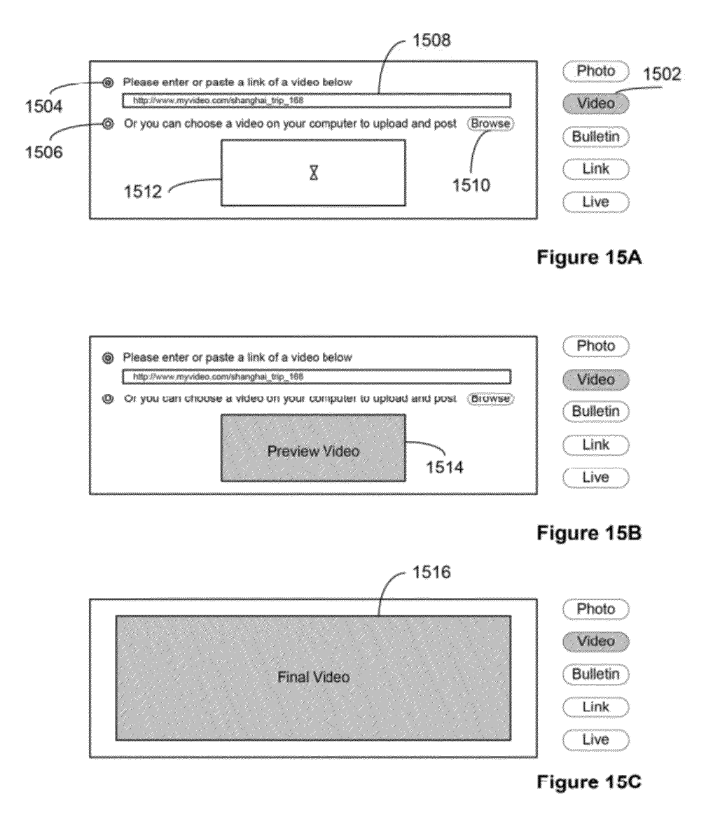

FIGS. 15A-15C illustrate methods for attaching videos to a business card according to embodiments of the present invention. For simplicity, only information associated with the space 1322 and the five buttons 1324-1332 of FIG. 13B are shown. In the example FIG. 15A, a user may initiate the method of attaching a video clip by clicking the Video button 1502. During the process of attaching the video clip, the Video button 1502 remains to be highlighted to indicate to the user the particular task being performed. In the display, the messages “Please enter or paste a link of a video below” and “Or you can choose a video on your computer to upload and post” are shown to the user. If the user chooses to enter or paste a link of a video, he selects this option by clicking the circle 1504 (as shown) and then enters a link of a video clip, for example http://www.mvvideo.com/shaghai_trip_168 in the space 1508. Alternatively, if the user chooses a video clip on his computer to upload and post, he would click on the circle 1506, and then use the Browse button 1510 to select a video clip from his computer to upload and post. An indicator is shown in the space 1512 to inform the user to wait for the video clip to be uploaded. In FIG. 15B, once the video clip is uploaded, a preview video 1514 is shown to the user. After the user approves the preview video 1514, a final video 1516 is attached to the business card as shown in FIG. 15C.

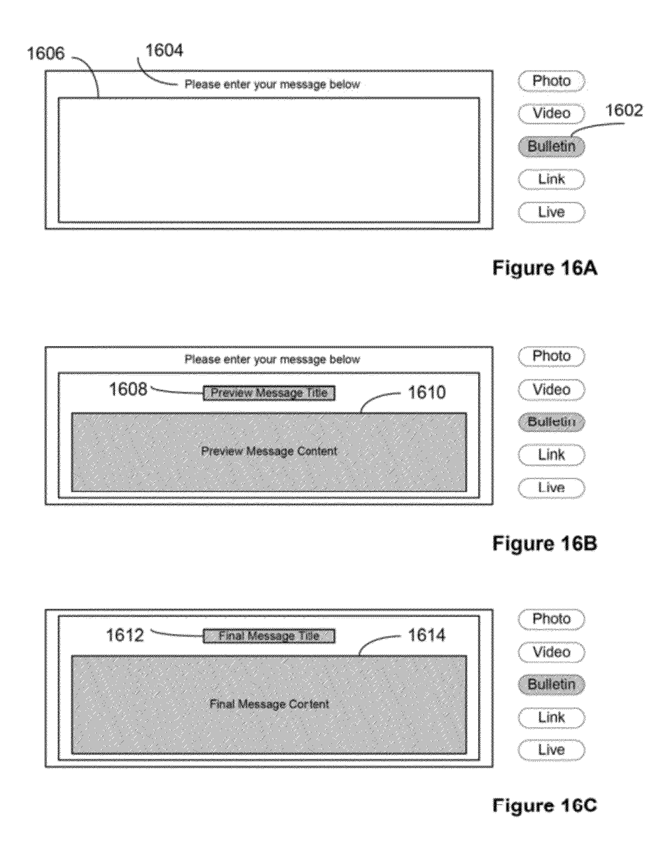

FIGS. 16A-16C illustrate methods for attaching message bulletin to a business card according to embodiments of the present invention. For simplicity, only information associated with the space 1322 and the five buttons 1324-1332 of FIG. 13B are shown. In the exemplary FIG. 16A, a user may initiate the method of attaching a message by clicking the Bulletin button 1602. During the process of attaching the message to the bulletin, the Bulletin button 1602 remains to be highlighted to indicate to the user the particular task being performed. In the display, the messages “Please enter your message below” is shown to the user. And a space 1606 is provided for the user to enter his message. In FIG. 16B, once the user has entered his message, a preview message title 1608 and preview message content 1610 are shown to the user. After the user approves the preview message title 1608 and preview message content 1610, a final message title 1612 and final message content 1614 are attached to the business card as shown in FIG. 16C.

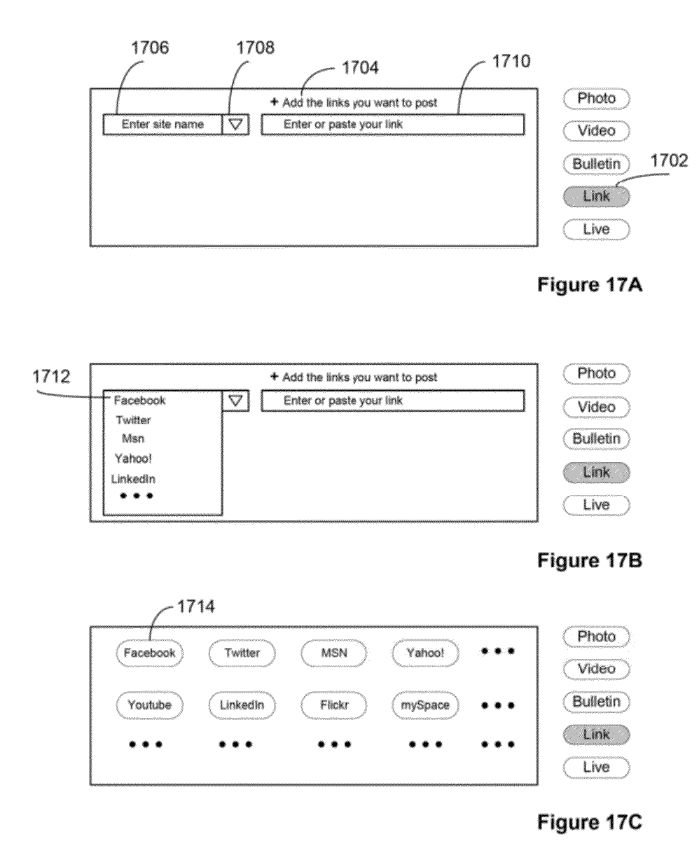

FIGS. 17A-17C illustrate methods for attaching links to a business card according to embodiments of the present invention. For simplicity, only information associated with the space 1322 and the five buttons 1324-1332 of FIG. 13B are shown. As shown in FIG. 17A, a user may initiate the method of attaching a link by clicking the Link button 1702. During the process of attaching the Link, the Link button 1702 remains to be highlighted to indicate to the user the particular task being performed. In the display, the message “+Add the links you want to post” 1704 is shown to the user. And a space 1706 is provided for the user to enter a website name. The user may store a list of websites which are accessible using the pull-down menu button 1708. The user may enter or paste a link in the space 1710.

In FIG. 17B, The user may store a list of his favorite websites, such as popular social network websites Facebook, Twitter, LinkedIn, Yahoo! Groups, mySpace, Flickr, Youtube, MSN, etc. The user may view his previously stored websites using the pull-down menu button 1708. After the user adds the website links he wants to post, a set of links are attached to the business card and displayed as shown in FIG. 17C.

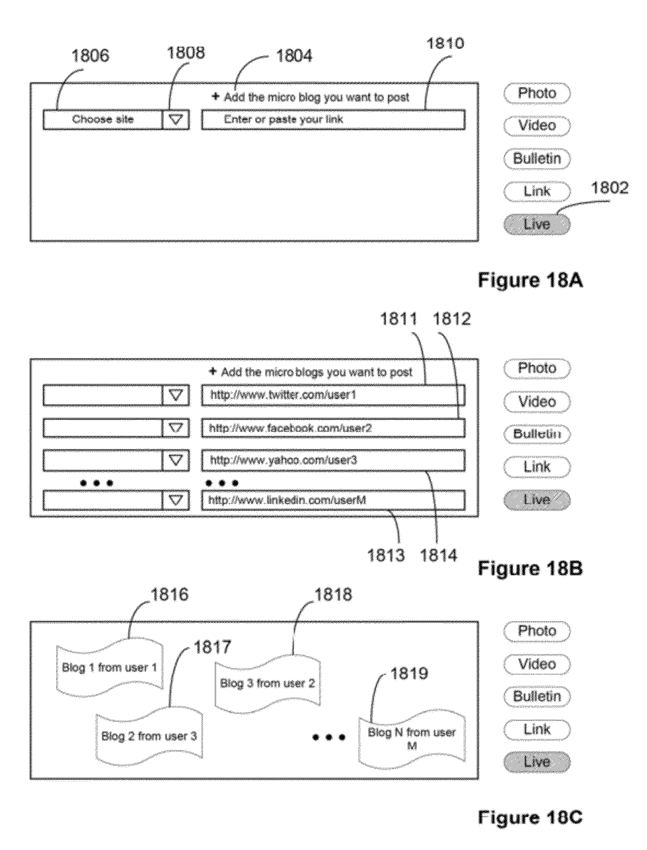

FIGS. 18A-18C illustrate methods for attaching live blogs to a business card according to embodiments of the present invention. For simplicity, only information associated with the space 1322 and the five buttons 1324-1332 of FIG. 13B are shown. According to the example shown in FIG. 18A, a user may initiate the method of attaching a live feed/chat by clicking the Live button 1802. During the process of attaching the live feed/chat, the Live button 1802 remains to be highlighted to indicate to the user the particular task being performed. In the display, the user is prompted with the message “+Add the micro blog you want to post” 1804. And a space 1806 is provided for the user to enter a website where the live feed/chat would come from. The user may store a list of websites which are accessible using the pull-down menu button 1808. The user may enter or paste a link in the space 1810.

In FIG. 18B, The user may store a list of websites for the live feed/chat, such as popular social network websites Facebook, Twitter, LinkedIn, Yahoo! Groups, mySpace, Flickr, Youtube, MSN, etc. For example, live feeds would be received from http://www.twitter.com/user1 1811, http://www.facebook.com/user2 1812, http://www.yahoo.com/user3 1813, http://www.linkedin.com/userM 1814, and so on. After setting up the links where the user would receive live feeds from, in FIG. 18C, multiple blogs are provided live to the back of the business card, such as blog 1 from user 1 (1816), blog 2 from user 3 (1817), blog 3 from user 2 (1818), blog N from user M, and so on. Via such interactive communication channel, the user receives a live communication with his friends and customers.

In one implementation of the live communications of the present invention, the Macromedia Flash may be used as platform of development. In particular, the RSS data feed is implemented as a Macromedia Flash Plug-In. RSS is a family of XML dialects for web syndication used by news websites and weblogs. The technology of RSS allows Internet users to subscribe to websites that have provided RSS feeds, which are typically websites that change or add content regularly. To use this technology, site owners create or obtain specialized software (such as a content management system) that, in the machine-readable XML format, presents new articles in a list, and provides a line or two of each article and a link to the full article.

The RSS formats provide web content or summaries of web content with links to the full versions of the content and other meta-data. This information is delivered as an XML file called an RSS feed, web-feed, RSS stream, or RSS channel. In addition to facilitating syndication, RSS allows a website's frequent readers to track updates on the site using an aggregator.

RSS may also be used by the weblog community to share the latest entries of headline news and their corresponding full text, and attached multimedia files to the news, such as podcasting, vodcasting, broadcasting, screencasting, Vloging, and MP3 blogs. The use of RSS has been adopted by certain news organizations, including Reuters, CNN, and the BBC. These news providers allow other websites to incorporate their “syndicated” headlines or headlines and short summary feeds under various usage arrangements. RSS may also be used for other purposes, including any other activities that involve periodic updates or publications.

In one approach, a program known as a feed reader or aggregator can check RSS-enabled web pages on behalf of a user and display any updated articles that it finds. RSS feeds may be found on major and smaller websites, as well as on Blog sites.

Client-side readers and aggregators are typically constructed as standalone programs or extensions to existing programs like web browsers. Browsers are moving toward integrated feed reader functions, for example Opera and Mozilla Firefox. Such programs are available for various operating systems. Web-based feed readers and news aggregators require no software installation and make the user's feeds available on any computer with Web access. Some aggregators combine RSS feeds into new feeds, for example taking all football-related items from several sports feeds to provide a new football feed. There are also search engines for content published via RSS feeds like Feedster or Blogdigger. On web pages, RSS feeds are typically linked with the letters XML or RSS.

It will be appreciated that the above descriptions for clarity have described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processors or controllers. Hence, references to specific functional units are to be seen as references to suitable means for providing the described functionality rather than indicative of a strict logical or physical structure or organization.

The invention can be implemented in any suitable form, including hardware, software, firmware, or any combination of these. The invention may optionally be implemented partly as computer software running on one or more data processors and/or digital signal processors. The elements and components of an embodiment of the invention may be physically, functionally, and logically implemented in any suitable way. Indeed, the functionality may be implemented in a single unit, in a plurality of units, or as part of other functional units. As such, the invention may be implemented in a single unit or may be physically and functionally distributed between different units and processors.

One skilled in the relevant art will recognize that many possible modifications and combinations of the disclosed embodiments may be used, while still employing the same basic underlying mechanisms and methodologies. The foregoing description, for purposes of explanation, has been written with references to specific embodiments. However, the illustrative discussions above are not intended to be exhaustive or to limit the invention to the precise forms disclosed. Many modifications and variations are possible in view of the above teachings. The embodiments were chosen and described to explain the principles of the invention and their practical applications, and to enable others skilled in the art to best utilize the invention and various embodiments with various modifications as suited to the particular use contemplated.

What is claimed is:

1. An electronic business card, comprising:
a front side of the business card configured to include business contact information;
a back side of the business card configured to include multimedia contents attached to the business card;
a privacy setting configured to set permissions of accessibility to the business card; and
an editor configured to edit contents on both the front side and back side of the business card.

2. The electronic business card of claim 1, wherein the business contact information comprises:
company logo, company name, company address, company web address, a person's name, title, telephone number, facsimile number, and email address, wherein each category is accessible and editable by the editor as a unit.

3. The electronic business card of claim 1, wherein the privacy setting comprises:
private, members-only, user-defined-group-only, and public.

4. The electronic business card of claim 1, wherein the back side of the business card comprises:
a user interface configured to post photos, wherein the user interface selects and uploads a photo to be posted and displays a preview photo and a final photo on the back side of the business card.

5. The electronic business card of claim 1, wherein the back side of the business card further comprises:
a user interface configured to post videos, wherein the user interface selects and uploads a video to be posted and displays a preview video and a final video on the back side of the business card.

6. The electronic business card of claim 1, wherein the back side of the business card further comprises:
a user interface configured as a bulletin for posting messages, wherein the user interface displays a preview message and displays a final message on the back side of the business card.

7. The electronic business card of claim 1, wherein the back side of the business card further comprises:
a user interface configured to receive web contents from one or more sources, wherein the user interface selects web contents to receive and displays the web contents on the back side of the business card.

8. The electronic business card of claim 1, wherein the back side of the business card further comprises:
a user interface configured to receive live blogs from other users, wherein the user interface selects one or more sources to receive the live blogs and displays the one or more live blogs on the back side of the business card.

9. A computer-implemented method for online communication using business cards, comprising:
receiving a business card in image format;
conducting an optical character recognition (OCR) conversion process to produce an equivalent business card in text format;
identifying keywords of the equivalent business card in text format;
linking the keywords with the business card in image format and the corresponding equivalent business card in text format;
attaching user-provided privacy setting of permissions of accessibility to the business card;
attaching user-provided contents to the business card; and
providing information of the business card and its associated contents online to one or more users according to the user-provided privacy setting of permissions of accessibility to the business card.

10. The computer-implemented method of claim 9, wherein user-provided privacy setting comprises at least one of:
private;
members-only;
user-defined-group-only; and
public.

11. The computer-implemented method of claim 9, wherein attaching user-provided contents comprises:
providing a user interface configured to select and upload a photo to be posted; and
storing the photo and its correlation with the business card in a relational database.

12. The computer-implemented method of claim 9, wherein attaching user-provided contents further comprises:
providing a user interface configured to select and upload a video to be posted; and
storing the video and its correlation with the business card in a relational database.

13. The computer-implemented method of claim 9, wherein attaching user-provided contents further comprises:
providing a user-interface configured as a bulletin for posting messages; and
storing messages and their correlation with the business card in a relational database.

14. The computer-implemented method of claim 9, wherein attaching user-provided contents further comprises:
providing a user interface configured to select web contents to be received from one or more sources; and
storing the web contents and their correlation with the business card in a relational database.

15. The computer-implemented method of claim 9, wherein attaching user-provided contents further comprises:
providing a user interface configured to select live blogs to be received from one or more sources; and
storing the live blogs and their correlation with the business card in a relational database.

16. The computer-implemented method of claim 9 further comprising:
sharing the business card online using a web interface; and
providing interactive instructions for accessing information of the business card.

17. The computer-implemented method of claim 9 further comprising:
sharing the business card online as an attachment of an electronic mail; and
providing interactive instructions for accessing information of the business card.

18. A computer-implemented method for searching image-based data, comprising:
receiving an image-based document;
conducting an optical character recognition (OCR) conversion process to produce an equivalent document in text format;
identifying keywords of the equivalent document in text format;
linking the keywords with the image-based document and the corresponding equivalent document in text format;
storing the image-based document, the corresponding equivalent document in text format, and the keywords in a relational database;
searching against the keywords and the equivalent document in text format in the relational database in accordance with a search query; and
displaying the image-based document and the corresponding equivalent document in text format in response to one or more keywords that match the search query as search results.

19. The computer-implemented method of claim 18, wherein searching against the keywords and the equivalent document in text format in the relational database comprises:
searching according to a user-provided privacy setting of permissions of accessibility to the business card; and
if the user-provided privacy setting of permissions of accessibility is set to public, providing access of the business card to the public.

20. The computer-implemented method of claim 18, wherein searching against the keywords and the equivalent document in text format in the relational database further comprises:
searching according to a user-provided privacy setting of permissions of accessibility to the business card; and
if the user-provided privacy setting of permissions of accessibility is set to members-only, providing access of the business card to members of an organization specified by the user.

21. The computer-implemented method of claim 18, wherein searching against the keywords and the equivalent document in text format in the relational database comprises:
searching according to a user-provided privacy setting of permissions of accessibility to the business card; and
if the user-provided privacy setting of permissions of accessibility is set to user-defined-group-only, providing access of the business card to members of a user-defined group.

22. The computer-implemented method of claim 18, wherein searching against the keywords and the equivalent document in text format in the relational database comprises:
searching according to a user-provided privacy setting of permissions of accessibility to the business card; and
if the user-provided privacy setting of permissions of accessibility is set to private, providing access of the business card to the user only.
